(19) United States
(12) Patent Application Publication
(10) Pub. No.: US 2013/0195187 A1
(43) Pub. Date: Aug. 1, 2013

(54) IMAGE PROCESSING DEVICE, IMAGE PROCESSING METHOD, AND PROGRAM

(71) Applicant: Kenji Kondo, Tokyo (JP)

(72) Inventor: Kenji Kondo, Tokyo (JP)

(73) Assignee: SONY CORPORATION, Tokyo (JP)

(21) Appl. No.: 13/877,393

(22) PCT Filed: Nov. 29, 2011
(86) PCT No.: PCT/JP2011/077509

§ 371 Date: Apr. 2, 2013

(30) Foreign Application Priority Data
Dec. 7, 2010 (JP) 2010272806

(51) Int. Cl. H04N 7/26

(52) U.S. Cl. CPC H04N 19/00569
USPC 375/240.12

(57) ABSTRACT

The present invention relates to an image processing device, an image processing method, and a program that can reduce processing loads and delays while suppressing decreases in inter prediction precision when motion compensation operations with fractional precision are performed in inter predictions. When a pixel of a predicted image in an inter prediction has a fractional pixel position that is not a ½ pixel position in the horizontal direction and the vertical direction in a reference image, a reference image read unit 41 reads predetermined reference pixels including reference pixels aligned in two oblique directions perpendicular to each other. A FIR filter 42 calculates a pixel in a fractional position in the reference image as the pixel of the predicted image, by using the read predetermined reference pixels. The present invention can be applied to encoding devices that perform compression encoding by H.264/AVC, for example.

### TECHNICAL FIELD

The present invention relates to image processing devices, image processing methods, and programs, and more particularly, to an image processing device, an image processing method, and a program that can reduce processing loads and delays while suppressing decreases in inter prediction precision when motion compensation operations with fractional precision are performed in inter predictions.

### BACKGROUND ART

As a standard for image compression, there is H.264/MPEG (Moving Picture Experts Group)-4 Part10 Advanced Video Coding (hereinafter referred to as H.264/AVC).

According to H.264/AVC, inter predictions are performed by taking advantage of correlations between frames or fields. In an inter prediction, a motion compensation operation is performed by using a part of a referable image that has already been stored, and a predicted image is generated.

In recent years, there have been attempts to improve the motion vector resolution in motion compensation operations so as to achieve fractional precision such as ½ or ¼.

In such a motion compensation operation with fractional precision, virtual pixels having fractional positions, called Sub pels, are set between adjacent pixels in a reference image, and operations to generate the Sub pels are additionally performed (hereinafter referred to as interpolations) (see Patent Document 1, for example). That is, in a motion compensation operation with fractional precision, the lowest motion vector resolution is a fractional multiple of the number of pixels, and therefore, interpolations to generate pixels in fractional positions are performed.

Interpolation filters (IF) used in interpolations are normally finite impulse response (FIR) filters.

For example, in conventional interpolations, 6-tap FIR filters are used as interpolation filters. Also, as interpolation filter structures, there are non-separable 2D structures and separable 2D structures.

In a case where an interpolation filter with a non-separable 2D structure is used, each Sub pel is generated by performing a single calculation on 6×6 pixels having integer positions for each Sub pel. In this case, the amount of delay is small, as each Sub pel is generated through a single calculation. However, the processing load is large, since the required number of times a calculation is performed is equal to the square of the number of taps.

In a case where an interpolation filter with a separable 2D structure is used, on the other hand, calculations for generating Sub pels having fractional positions in the horizontal direction are performed independently of calculations for generating Sub pels having fractional positions in the vertical direction.

For example, a Sub pel b having a ½ pixel position only in the horizontal direction as shown in FIG. 1 is generated by performing a calculation using the six pixels in integer positions that are represented by shaded squares and are located in the same positions as the Sub pel b in the horizontal direction. A Sub pel h having a ½ pixel position only in the vertical direction is generated by performing a calculation using the six pixels in integer positions that are represented by shaded squares and are located in the same positions as the Sub pel h in the vertical direction.

Further, a Sub pel j having a ½ pixel position in both the horizontal direction and the vertical direction is generated by performing a calculation using 6×6 pixels in integer positions represented by the shaded squares six times, using six pixels aligned in a horizontal line at a time, and then performing a calculation using the six pixels that are obtained as a result of the calculations and have the same positions as the Sub pel j in the horizontal direction. Pixels a, c through g, i, and k through o in ¼ pixel positions are generated by using the pixels b, h, and j, or the pixels in the integer positions represented by the shaded squares on both sides.

In FIG. 1, the squares having no alphabetical characters assigned thereto represent pixels in integer positions, and the squares having alphabetical characters assigned thereto represent the Sub pels of the respective alphabetical characters. The same applies to FIG. 3 described later.

As shown in FIG. 1, in conventional interpolations, a maximum of 6×6 pixels around Sub pels to be generated through interpolations are required. Therefore, in a motion compensation operation with fractional precision, pixels in a much larger area than the target block of the motion compensation operation are required.

As shown in FIG. 2, a fractional-precision motion compensation operation to be performed on a block of 4×4 pixels requires the 4×4 pixels represented by the dotted squares corresponding to the block, and the 9×9 pixels including the pixels represented by the shaded squares on the outside of the 4×4 pixels. Therefore, in a case where motion compensation operations with fractional precision are performed in inter predictions, usage of the bandwidth of the memory that stores reference images is large.

In a case where an interpolation filter with a separable 2D structure is used, not all Sub pels need to be generated by using 6×6 pixels in integer positions. Accordingly, the processing load is smaller than that in a case where an interpolation filter with a non-separable 2D structure is used, but the number of times a calculation is performed is larger. Particularly, when the Sub pel j is generated, the calculation involving the 6×6 pixels in integer positions is performed six times, by using six pixels aligned in a horizontal line at a time. After that, a calculation needs to be performed by using the six pixels obtained as a result of the calculations. Therefore, the number of times a calculation is performed is large, and the amount of delay is also large.

In view of this, to reduce processing loads and delays in interpolation filters, there is a suggested method of generating each of the Sub pels e, g, j, m, and by performing a single calculation using pixels that have integer positions and are aligned in oblique directions, as shown in FIG. 3.

Specifically, according to the method illustrated in FIG. 3, the Sub pel e and the Sub pel o are generated through a single calculation using the six pixels represented by the sparsely-dotted squares. Also, the Sub pel g and the Sub pel m are generated through a single calculation using the six pixels represented by the densely-dotted squares. Further, the Sub pel j is generated through a single calculation using both the six pixels represented by the sparsely-dotted squares and the six pixels represented by the densely-dotted squares.

### CITATION LIST

### Non-Patent Document

Non-Patent Document 1: Dmytro Rusanovskyy, Kemal Ugur, Antti Hallapuro, Jani Lainema, and Moncef Gabbouj, Video Coding With Low-Complexity Directional Adaptive Interpolation Filters, IEEE TRANSACTIONS ON CIRCUITS AND SYSTEMS FOR VIDEO TECHNOLOGY, AUGUST 2009, VOL. 19, No. 8

### SUMMARY OF THE INVENTION

### Problems to be Solved by the Invention

According to the method illustrated in FIG. 3, in the interpolation with the Sub pel e, the six pixels represented by the sparsely-dotted squares aligned in an oblique direction are used, and accordingly, the characteristics of the Sub pel e are desirable in the oblique direction. However, in a direction perpendicular to the direction in which the six pixels represented by the sparsely-dotted squares are aligned, or in the direction in which the six pixels represented by the densely-dotted squares are aligned, the characteristics of the Sub pel e become poorer, and as a result, inter prediction precision becomes lower. The same applies to the Sub pels o, g, and m.

Also, in the interpolation with the Sub pel j, the six pixels represented by the sparsely-dotted squares and the six pixels represented by the densely-dotted squares, which are aligned in two oblique directions perpendicular to each other, are used. Accordingly, the characteristics of the Sub pel j are desirable in the oblique directions. However, the characteristics of the Sub pel j become poorer in the horizontal direction and the vertical direction, and as a result, inter prediction precision becomes lower.

The present invention has been made in view of such circumstances, and is to reduce processing loads and delays while suppressing decreases in inter prediction precision.

### Solutions to Problems

An image processing device of one aspect of the present invention includes: a pixel read means that reads predetermined pixels from a reference image in an inter prediction; and an arithmetic operation means that calculates a pixel in a fractional pixel position in the reference image as a pixel of a predicted image in the inter prediction, by using the predetermined pixels read by the pixel read means. When the pixel in the predicted image has a fractional pixel position that is not a ½ pixel position in the horizontal direction and the vertical direction in the reference image, the pixel read means reads the predetermined pixels including pixels aligned in two oblique directions perpendicular to each other in the reference image.

An image processing method and a program of the one aspect of the present invention are compatible with the image processing device of the one aspect of the present invention.

In the one aspect of the present invention, predetermined pixels are read from a reference image in an inter prediction, and a pixel in a fractional pixel position in the reference image is calculated as a pixel of a predicted image in the inter prediction by using the read predetermined pixels. When the pixel of the predicted image has a fractional pixel position that is not a ½ pixel position in both the horizontal direction and the vertical direction in the reference image, the predetermined pixels include pixels aligned in two oblique directions perpendicular to each other in the reference image.

### Effects of the Invention

According to the present invention, processing loads and delays can be reduced, while decreases in inter prediction precision are suppressed.

### BRIEF DESCRIPTION OF DRAWINGS

FIG. 1 is a diagram showing an example of pixels to be used in generating Sub pels.

FIG. 2 is a diagram showing a reference pixel range in a case where a motion compensation operation with fractional precision is performed.

FIG. 3 is a diagram showing another example of pixels to be used in generating Sub pels.

FIG. 4 is a block diagram showing an example structure of an embodiment of an encoding device as an image processing device to which the present invention is applied.

FIG. 5 is a block diagram showing an example structure of the inter prediction unit shown in FIG. 4.

FIG. 6 is a diagram showing an example of reference pixels to be used in generating predicted pixels that are Sub pels a, b, and c.

FIG. 7 is a diagram showing an example of reference pixels to be used in generating predicted pixels that are Sub pels d, h, and l.

FIG. 8 is a diagram showing an example of reference pixels to be used in generating predicted pixels that are Sub pels e and o.

FIG. 9 shows reference pixels that are at the same distance from the positions of the Sub pels e and o in the reference image.

FIG. 10 is a diagram showing another example of reference pixels to be used in generating predicted pixels that are the Sub pels e and o.

FIG. 11 is a diagram showing yet another example of reference pixels to be used in generating a predicted pixel that is the Sub pel e.

FIG. 12 is a diagram showing yet another example of reference pixels to be used in generating a predicted pixel that is the Sub pel o.

FIG. 13 is a diagram showing an example of reference pixels to be used in generating predicted pixels that are Sub pels g and m.

FIG. 14 shows reference pixels that are at the same distance from the positions of the Sub pels g and m in the reference image.

FIG. 15 is a diagram showing another example of reference pixels to be used in generating predicted pixels that are the Sub pels g and m.

FIG. 16 is a diagram showing yet another example of reference pixels to be used in generating a predicted pixel that is the Sub pel g.

FIG. 17 is a diagram showing yet another example of reference pixels to be used in generating a predicted pixel that is the Sub pel m.

FIG. 18 is a diagram showing an example of reference pixels to be used in generating a predicted pixel that is a Sub pel j.

FIG. 19 shows reference pixels that are at the same distance from the position of the Sub pel j in the reference image.

FIG. 20 is a diagram showing another example of reference pixels to be used in generating a predicted pixel that is the Sub pel j.

FIG. 21 is a diagram showing an example of reference pixels necessary for generating predicted pixels in arbitrary fractional positions.

FIG. 22 is a diagram showing an example of filter coefficients to be used in generating a predicted pixel that is the Sub pel e.

FIG. 23 is a diagram showing an example of filter coefficients to be used in generating a predicted pixel that is the Sub pel o.

FIG. 24 is a diagram showing an example of filter coefficients to be used in generating a predicted pixel that is the Sub pel g.

FIG. 25 is a diagram showing an example of filter coefficients to be used in generating a predicted pixel that is the Sub pel m.

FIG. 26 is a diagram showing an example of filter coefficients to be used in generating a predicted pixel that is the Sub pel j.

FIG. 27 is a first flowchart for explaining an encoding operation by the encoding device shown in FIG. 4.

FIG. 28 is a second flowchart for explaining the encoding operation by the encoding device shown in FIG. 4.

FIG. 29 is a flowchart for explaining an inter prediction operation in detail.

FIG. 30 is a block diagram showing an example structure of a decoding device as an image processing device to which the present invention is applied.

FIG. 31 is a flowchart for explaining a decoding operation by the decoding device shown in FIG. 30.

FIG. 32 is a block diagram showing an example structure of an embodiment of a computer.

FIG. 33 is a block diagram showing a typical example structure of a television receiver.

FIG. 34 is a block diagram showing a typical example structure of a portable telephone device.

FIG. 35 is a block diagram showing a typical example structure of a hard disk recorder.

FIG. 36 is a block diagram showing a typical example structure of a camera.

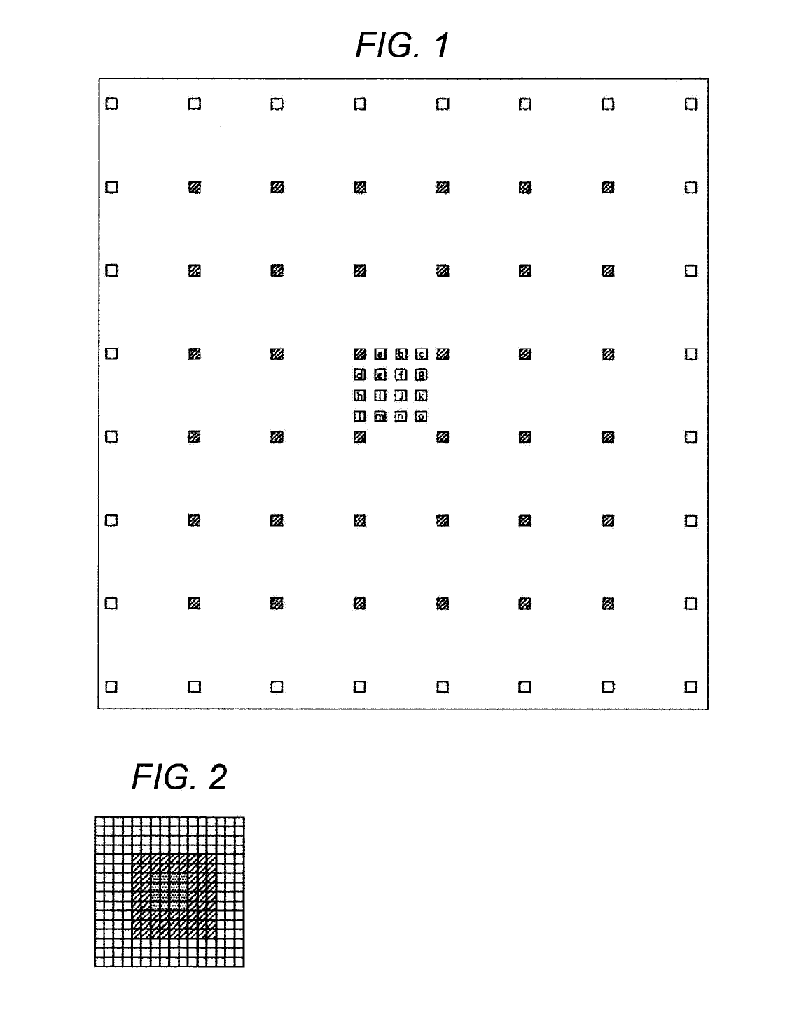

### MODE FOR CARRYING OUT THE INVENTION

### First Embodiment

### Example Structure of an Embodiment of an Encoding Device

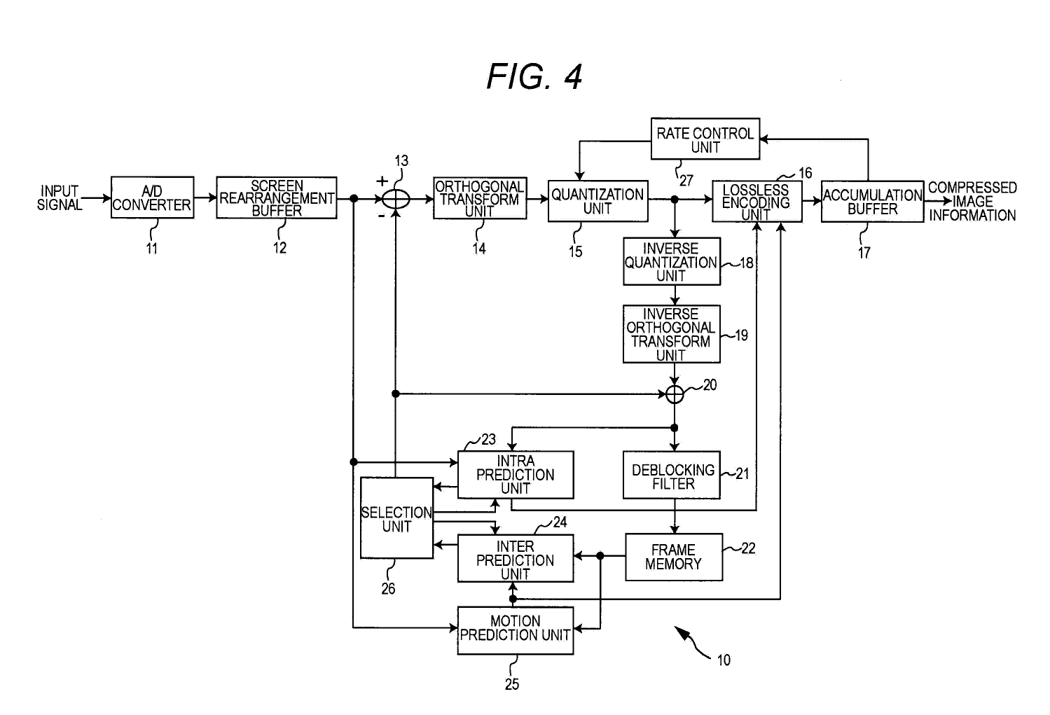

FIG. 4 is a block diagram showing an example structure of an embodiment of an encoding device as an image processing device to which the present invention is applied.

The encoding device 10 shown in FIG. 4 includes an A/D converter 11, a screen rearrangement buffer 12, an arithmetic operation unit 13, an orthogonal transform unit 14, a quantization unit 15, a lossless encoding unit 16, an accumulation buffer 17, an inverse quantization unit 18, an inverse orthogonal transform unit 19, an addition unit 20, a deblocking filter 21, a frame memory 22, an intra prediction unit 23, an inter prediction unit 24, a motion prediction unit 25, a selection unit 26, and a rate control unit 27. The encoding device 10 shown in FIG. 4 performs compression encoding on input images by H.264/AVC.

Specifically, the A/D converter 11 of the encoding device 10 performs an A/D conversion on a frame-based image input as an input signal, and outputs and stores the image into the screen rearrangement buffer 12. The screen rearrangement buffer 12 rearranges the frames of the image stored in displaying order, so that the frames of the image are arranged in encoding order in accordance with the GOP (Group of Pictures) structure. The rearranged frame-based image is output to the arithmetic operation unit 13, the intra prediction unit 23, and the motion prediction unit 25.

The arithmetic operation unit 13 functions as a difference calculation means, and calculates the difference between a predicted image supplied from the selection unit 26 and an encoding target image output from the screen rearrangement buffer 12. Specifically, the arithmetic operation unit 13 subtracts a predicted image supplied from the selection unit 26 from an encoding target image output from the screen rearrangement buffer 12. The arithmetic operation unit 13 outputs the image obtained as a result of the subtraction, as residual error information to the orthogonal transform unit 14. When any predicted image is not supplied from the selection unit 26, the arithmetic operation unit 13 outputs an image read from the screen rearrangement buffer 12 as the residual error information to the orthogonal transform unit 14.

The orthogonal transform unit 14 performs an orthogonal transform, such as a discrete cosine transform or a Karhunen-Loeve transform, on the residual error information supplied from the arithmetic operation unit 13, and supplies the resultant coefficients to the quantization unit 15.

The quantization unit 15 quantizes the coefficients supplied from the orthogonal transform unit 14. The quantized coefficients are input to the lossless encoding unit 16.

The lossless encoding unit 16 obtains information indicating an optimum intra prediction mode (hereinafter referred to as intra prediction mode information) from the intra prediction unit 23, and obtains information indicating an optimum inter prediction mode (hereinafter referred to as inter prediction mode information), a motion vector, and the like from the inter prediction unit 24.

The lossless encoding unit 16 performs lossless encoding, such as variable-length encoding (CAVLC (Context-Adaptive Variable Length Coding), for example) or arithmetic encoding (CABAC (Context-Adaptive Binary Arithmetic Coding), for example), on the quantized coefficients supplied from the quantization unit 15, and turns the resultant information into a compressed image. The lossless encoding unit 16 also performs lossless encoding on the intra prediction mode information, or on the inter prediction mode information, the motion vector, and the like, and turns the resultant information into header information to be added to the compressed image. The lossless encoding unit 16 supplies and stores the compressed image to which the header information obtained as a result of the lossless encoding is added, as compressed image information into the accumulation buffer 17.

The accumulation buffer 17 temporarily stores the compressed image information supplied from the lossless encoding unit 16, and outputs the compressed image information to a recording device, a transmission path, or the like (not shown) in a later stage, for example.

The quantized coefficients that are output from the quantization unit 15 are also input to the inverse quantization unit 18, and after inversely quantized, are supplied to the inverse orthogonal transform unit 19.

The inverse orthogonal transform unit 19 performs an inverse orthogonal transform such as an inverse discrete cosine transform or an inverse Karhunen-Loeve transform on the coefficients supplied from the inverse quantization unit 18, and supplies the resultant residual error information to the addition unit 20.

The addition unit 20 functions as an adding operation means that adds the residual error information supplied as the decoding target image from the inverse orthogonal transform unit 19 to a predicted image supplied from the selection unit 26, and obtains a locally decoded image. If there are no predicted images supplied from the selection unit 26, the addition unit 20 sets the residual error information supplied from the inverse orthogonal transform unit 19 as a locally decoded image. The addition unit 20 supplies the locally decoded image to the deblocking filter 21, and supplies the locally decoded image as a reference image to the intra prediction unit 23.

The deblocking filter 21 performs filtering on the locally decoded image supplied from the addition unit 20, to remove block distortions. The deblocking filter 21 supplies and stores the resultant image into the frame memory 22. The image stored in the frame memory 22 is then output as a reference image to the inter prediction unit 24 and the motion prediction unit 25.

Based on the image read from the screen rearrangement buffer 12 and the reference image supplied from the addition unit 20, the intra prediction unit 23 performs intra predictions in all candidate intra prediction modes, and generates predicted images.

The intra prediction unit 23 also calculates cost function values (described later in detail) for all the candidate intra prediction modes. The intra prediction unit 23 then determines the intra prediction mode with the smallest cost function value to be the optimum intra prediction mode. The intra prediction unit 23 supplies the predicted image generated in the optimum intra prediction mode and the corresponding cost function value to the selection unit 26. When notified of selection of the predicted image generated in the optimum intra prediction mode by the selection unit 26, the intra prediction unit 23 supplies the intra prediction mode to the lossless encoding unit 16.

It should be noted that a cost function value is also called a RD (Rate Distortion) cost, and is calculated by the technique of High Complexity mode or Low Complexity mode, as specified in the JM (Joint Model), which is the reference software in H.264/AVC, for example.

Specifically, where the High Complexity mode is used as a method of calculating cost function values, operations ending with the lossless encoding are provisionally carried out on all candidate prediction modes, and a cost function value expressed by the following equation (1) is calculated for each of the prediction modes.

Cost(Mode)=D+λ·R (1)

D represents the difference (distortion) between the original image and the decoded image, R represents the bit generation rate including the orthogonal transform coefficient, and λ represents the Lagrange multiplier given as the function of a quantization parameter QP.

Where the Low Complexity mode is used as the method of calculating cost function values, on the other hand, decoded images are generated, and header bits such as information indicating a prediction mode are calculated in all the candidate prediction modes. A cost function value expressed by the following equation (2) is then calculated for each of the prediction modes.

Cost(Mode)=D+QPtoQuant(QP)·Header_Bit (2)

D represents the difference (distortion) between the original image and the decoded image, Header_Bit represents the header bit corresponding to the prediction mode, and QPtoQuant is the function given as the function of the quantization parameter QP.

In the Low Complexity mode, decoded images are simply generated in all the prediction modes, and there is no need to perform lossless encoding. Accordingly, the amount of calculation is small. It should be noted that the High Complexity mode is used as the method of calculating cost function values herein.

Based on inter prediction mode information and a motion vector supplied from the motion prediction unit 25, the inter prediction unit 24 reads the reference image from the frame memory 22. Based on the motion vector and the reference image read from the frame memory 22, the inter prediction unit 24 performs an inter prediction operation. Specifically, the inter prediction unit 24 performs interpolations on the reference image based on the motion vector, to perform a motion compensation operation with fractional precision. The inter prediction unit 24 supplies the resultant predicted image and a cost function value supplied from the motion prediction unit 25, to the selection unit 26. When notified of selection of the predicted image generated in the optimum inter prediction mode by the selection unit 26, the inter prediction unit 24 outputs the inter prediction mode information, the corresponding motion vector, and the like to the lossless encoding unit 16.

Based on the image supplied from the screen rearrangement buffer 12 and the reference image supplied from the frame memory 22, the motion prediction unit 25 performs a motion prediction operation in all the candidate inter prediction modes, and generates motion vectors with fractional precision. Specifically, the motion prediction unit 25 performs interpolations on the reference image in each inter prediction mode in the same manner as the inter prediction unit 24. In each inter prediction mode, the motion prediction unit 25 performs matching between the interpolated reference image and the image supplied from the screen rearrangement buffer 12, to generate a motion vector with fractional precision. In this embodiment, Sub pels in ½ pixel positions and ¼ pixel positions are generated through the interpolations, and the motion vector precision is ¼ pixel precision.

At this point, the motion prediction unit 25 calculates cost function values for all the candidate inter prediction modes, and determines the inter prediction mode with the smallest cost function value to be the optimum inter prediction mode. The motion prediction unit 25 then supplies the inter prediction mode information, the corresponding motion vector, and the corresponding cost function value to the inter prediction unit 24.

It should be noted that the inter prediction mode is information indicating the size of the block to be subjected to an inter prediction, the predicting direction, and the reference index. The sizes of blocks to be subjected to inter predictions include sizes of square blocks, such as 4×4 pixels, 8×8 pixels, 16×16 pixels, 32×32 pixels, and 64×64 pixels, and sizes of rectangular blocks, such as 4×8 pixels, 8×4 pixels, 8×16 pixels, 16×8 pixels, 16×32 pixels, 32×16 pixels, 32×64 pixels, and 64×32 pixels. As for predicting directions, there are forward predictions (“L0 prediction”) each using a reference image having an earlier display time than the image to be subjected to an inter prediction, and backward predictions (“L1 prediction”) each using a reference image having a later display time than the image to be subjected to an inter prediction. A reference index is a number for identifying a reference image, and an image that is located closer to an image to be subjected to an inter prediction has a smaller reference index number.

Based on the cost function values supplied from the intra prediction unit 23 and the inter prediction unit 24, the selection unit 26 determines the optimum intra prediction mode or the optimum inter prediction mode to be an optimum prediction mode. The selection unit 26 then supplies the predicted image in the optimum prediction mode to the arithmetic operation unit 13 and the addition unit 20. The selection unit 26 also notifies the intra prediction unit 23 or the inter prediction unit 24 of the selection of the predicted image in the optimum prediction mode.

Based on the compressed image information stored in the accumulation buffer 17, the rate control unit 27 controls the quantization operation rate of the quantization unit 15 so as not to cause an overflow or under flow.

### Example Structure of the Inter Prediction Unit

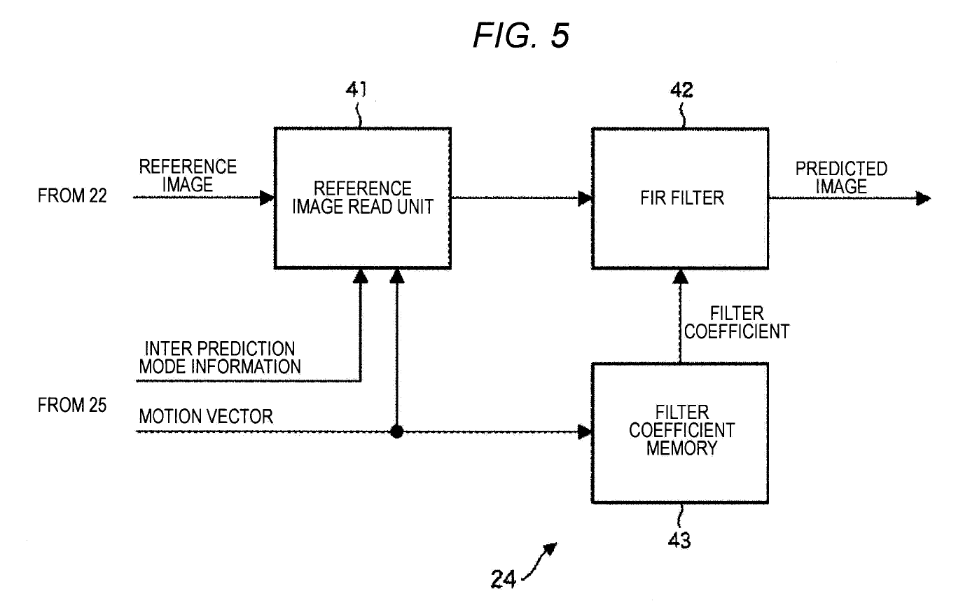

FIG. 5 is a block diagram showing an example structure of the inter prediction unit 24 shown in FIG. 4.

For ease of explanation, FIG. 5 shows only the blocks concerning the inter prediction operation of the inter prediction unit 24, and does not show blocks that output cost function values, inter prediction mode information, motion vectors, and the like.

In FIG. 5, the inter prediction unit 24 includes a reference image read unit 41, a FIR filter 42, and a filter coefficient memory 43.

Based on the reference index and the predicting direction contained in the inter prediction mode information supplied from the motion prediction unit 25 shown in FIG. 4, the reference image read unit 41 of the inter prediction unit 24 identifies the reference image among the images stored in the frame memory 22. Based on the block size contained in the inter prediction mode information and the integer value of the motion vector, the reference image read unit 41 reads, from the frame memory 22, the pixels of the reference image (hereinafter referred to as reference pixels) to be used in generating a predicted image, and temporarily stores those reference pixels.

The reference image read unit 41 functions as a pixel read means. For each of the pixels of a predicted image (hereinafter referred to as predicted pixels), the reference image read unit 41 reads the reference pixels to be used in generating the predicted pixel among the temporarily stored reference pixels. The reference image read unit 41 then supplies the read reference pixels to the FIR filter 42.

The FIR filter 42 functions as an arithmetic operation means, and performs a calculation by using the reference pixels supplied from the reference image read unit 41 and filter coefficients supplies from the filter coefficient memory 43. Specifically, the FIR filter 42 multiplies each reference pixel by the filter coefficient corresponding to the reference pixel, and adds the multiplication result to an offset value. In accordance with the position of the predicted pixel in the reference image, the FIR filter 42 supplies the one pixel obtained through the calculation as the predicted pixel to the selection unit 26 (FIG. 4), or performs a predetermined calculation on pixels obtained as a result of calculations and supplies the resultant one pixel as the predicted pixel to the selection unit 26.

The filter coefficient memory 43 stores filter coefficients for respective reference pixels associated with fractional values of motion vectors. Based on the fractional value of the motion vector supplied from the motion prediction unit 25 shown in FIG. 4, the filter coefficient memory 43 supplies the filter coefficients for the respective reference pixels stored and associated with the fractional value, to the FIR filter 42.

### Description of Reference Pixels

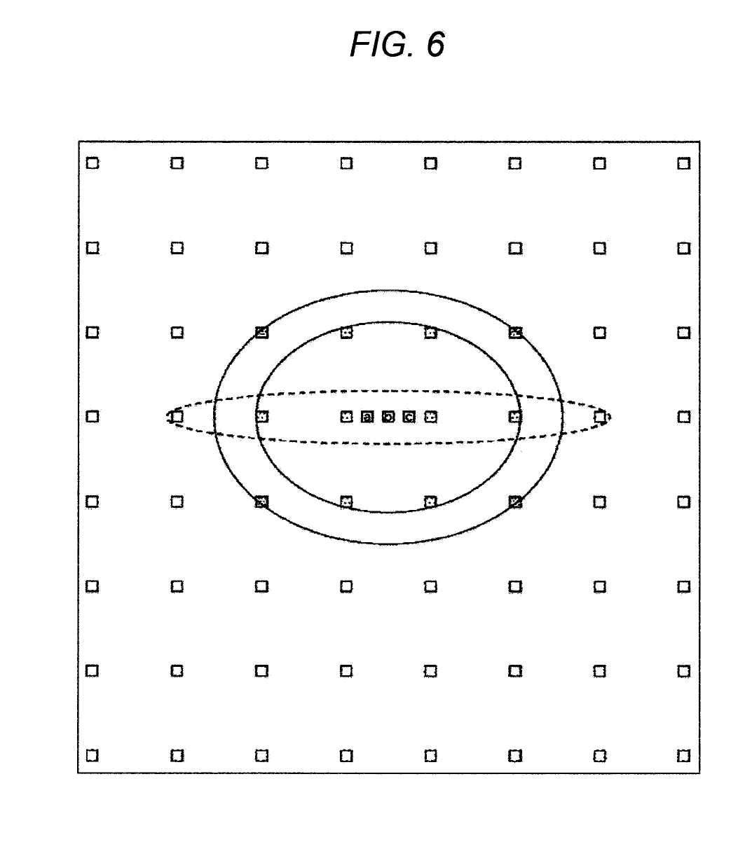

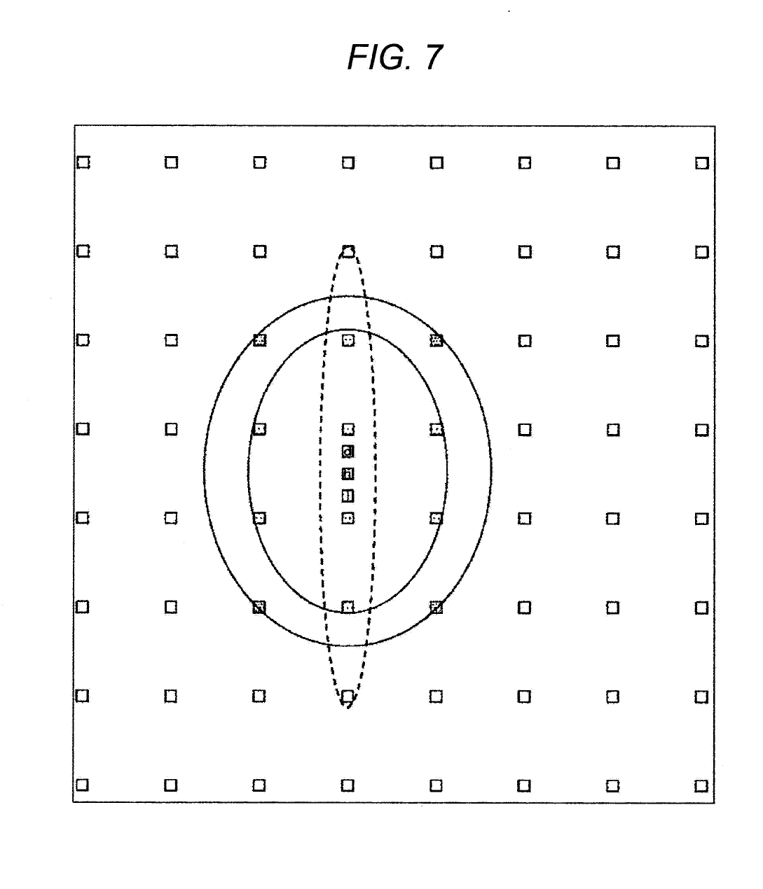

FIGS. 6 through 20 are diagrams for explaining examples of reference pixels to be used in generating predicted pixels.

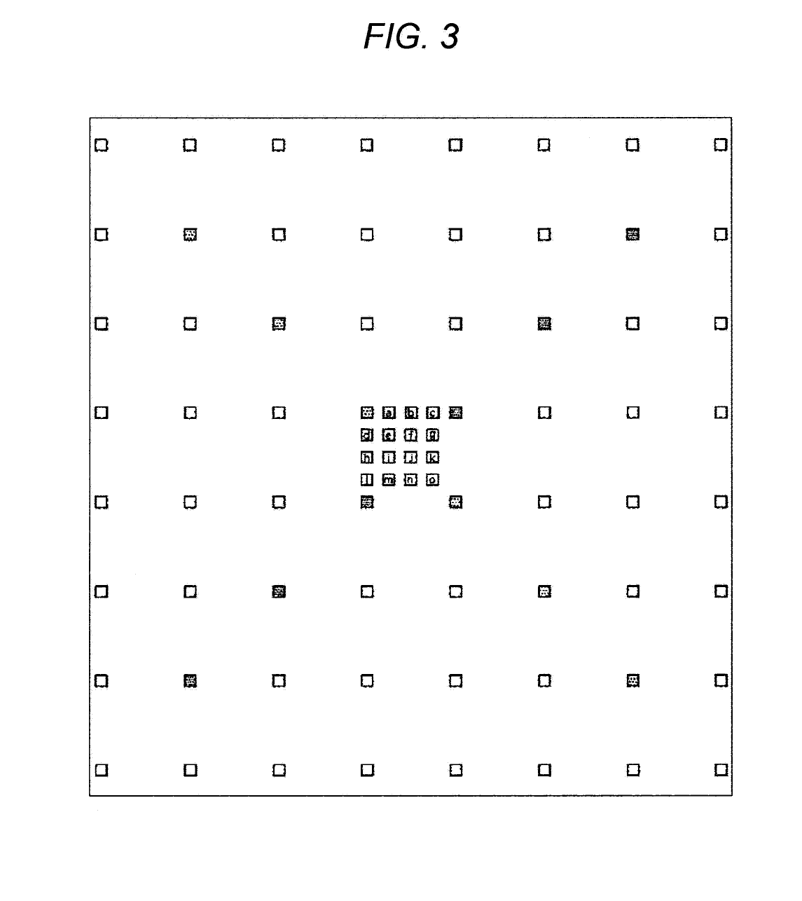

In FIGS. 6 through 20, the squares each having an alphabetical character assigned thereto represent Sub pels, and the squares without alphabetical characters represent reference pixels. The dotted squares represent reference pixels to be used in generating predicted pixels. Further, the solid-line circles surround reference pixels to be used in generating predicted pixels, and the dashed-line circles indicate that the reference pixels that are surrounded by the circles and are represented by the squares having no alphabetical characters assigned thereto are reference pixels to be used in generating predicted pixels by the conventional method illustrated in FIG. 3.

FIG. 6 is a diagram showing an example of reference pixels to be used in generating predicted pixels that have integer positions in the vertical direction and fractional positions in the horizontal direction.

As shown in FIG. 6, in a case where the predicted pixels are Sub pels a, b, and c, which have integer positions in the vertical direction and fractional positions in the horizontal direction, the eight reference pixels represented by the sparsely-dotted squares surrounded by the inner solid-line circle are used in generating the predicted pixels. Specifically, the reference pixels to be used in generating the predicted pixels are the four reference pixels consisting of two each on the right and left sides of the Sub pels a, b, and c, and the four reference pixels closest to the Sub pels a, b, and c among those located on the two vertical lines sandwiching the Sub pels a, b, and c with the exception of the four reference pixels on the right and left sides of the Sub pels a, b, and c.

Alternatively, the reference pixels to be used in generating the Sub pels a, b, and c may be the 4×3 reference pixels that are located around the Sub pels a, b, and c, are represented by the dotted squares surrounded by the outer solid-line circle, and further include the four reference pixels, represented by the densely-dotted squares shown in FIG. 6.

As described above, in the encoding device 10 shown in FIG. 4, when the predicted pixels are the Sub pels a, b, and c, which have integer positions in the vertical direction and fractional positions in the horizontal direction, the predicted pixels are generated by using not only reference pixels aligned in the horizontal direction but also reference pixels aligned in the vertical direction. Accordingly, the characteristics of the predicted pixels can be made desirable in both the horizontal direction and the vertical direction.

On the other hand, the reference pixels to be used according to the conventional method illustrated in FIG. 3 are the six reference pixels that consist of three each on the right and left sides of the Sub pels a, b, and c, as indicated by the squares surrounded by the dashed line in FIG. 6. According to the conventional method illustrated in FIG. 3, any reference pixels aligned in the vertical direction are not used. Therefore, the characteristics of the predicted pixels are not desirable in the vertical direction.

Also, in a case where the FIR filter 42 performs a SIMD (Single Instruction Multiple Data) calculation, if the number of reference pixels to be used in generating the Sub pels a, b, and c is eight, which is a power of 2, as shown in FIG. 6, the calculation can be efficiently performed.

Further, the positions of the reference pixels represented by the dotted squares surrounded by the solid-lines in FIG. 6 are closer to the Sub pels a, b, and c, compared with the reference pixels that are to be used according to the conventional method illustrated in FIG. 3 and are represented by the squares surrounded by the dashed line in FIG. 6.

FIG. 7 is a diagram showing an example of reference pixels to be used in generating predicted pixels that have integer positions in the horizontal direction and fractional positions in the vertical direction.

As shown in FIG. 7, in a case where the predicted pixels are Sub pels d, h, and l, which have integer positions in the horizontal direction and fractional positions in the vertical direction, the eight reference pixels represented by the sparsely-dotted squares surrounded by the inner solid-line circle are used in generating the predicted pixels. Specifically, the reference pixels to be used in generating the predicted pixels are the four reference pixels consisting of two each above and below the Sub pels d, h, and l, and the four reference pixels closest to the Sub pels d, h, and l among those located on the two horizontal lines sandwiching the Sub pels d, h, and l with the exception of the four reference pixels above and below the Sub pels d, h, and l.

Alternatively, the reference pixels to be used in generating the Sub pels d, h, and l may be the 3×4 reference pixels that are located around the Sub pels d, h, and l, are represented by the dotted squares surrounded by the outer solid-line circle, and further include the four reference pixels represented by the densely-dotted squares shown in FIG. 7.

As described above, in the encoding device 10, when the predicted pixels are the Sub pels d, h, and l, which have integer positions in the horizontal direction and fractional positions in the vertical direction, the predicted pixels are generated by using not only reference pixels aligned in the vertical direction but also reference pixels aligned in the horizontal direction. Accordingly, the characteristics of the predicted pixels can be made desirable in both the vertical direction and the horizontal direction.

On the other hand, the reference pixels to be used according to the conventional method illustrated in FIG. 3 are the six reference pixels that consist of three each above and below the Sub pels d, h, and l, as indicated by the squares surrounded by the dashed line in FIG. 7. According to the conventional method illustrated in FIG. 3, any reference pixels aligned in the horizontal direction are not used. Therefore, the characteristics of the predicted pixels are not desirable in the horizontal direction.

Also, in a case where the FIR filter 42 performs a SIMD calculation, if the number of reference pixels to be used in generating the Sub pels d, h, and l is eight, which is a power of 2, as shown in FIG. 7, the calculation can be efficiently performed.

Further, the positions of the reference pixels represented by the dotted squares surrounded by the solid-lines in FIG. 7 are closer to the Sub pels d, h, and l, compared with the reference pixels that are represented by the squares surrounded by the dashed line in FIG. 7 and are to be used according to the conventional method illustrated in FIG. 3.

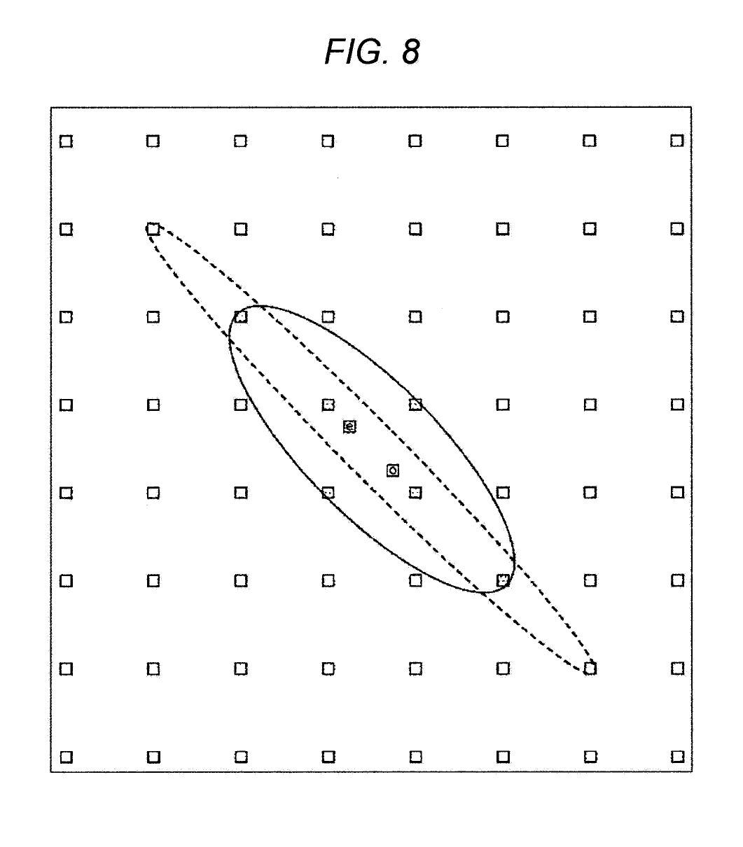

FIG. 8 is a diagram showing an example of reference pixels to be used in generating upper left and lower right predicted pixels that have ¼ pixel positions in both the horizontal direction and the vertical direction.

As shown in FIG. 8, in a case where the predicted pixels are upper left and lower right Sub pels e and o, which have ¼ pixel positions in both the horizontal direction and the vertical direction, the six reference pixels represented by the sparsely-dotted squares surrounded by the solid-line circle are used in generating the predicted pixels. Specifically, the reference pixels to be used in generating the predicted pixels are the four reference pixels closest to the Sub pels e and o among those aligned in the oblique direction in which the Sub pels e and o are aligned, and the two reference pixels closest to the Sub pels e and o among those aligned in a direction perpendicular to the oblique direction.

As described above, in the encoding device 10, when the predicted pixels are the upper left and lower right Sub pels e and o, which have ¼ pixel positions in both the horizontal direction and the vertical direction, the predicted pixels are generated by using not only reference pixels aligned in the oblique direction in which the Sub pels e and o are aligned, but also reference pixels aligned in a direction perpendicular to the oblique direction. Accordingly, the characteristics of the predicted pixels can be made desirable in the oblique direction.

On the other hand, the reference pixels to be used according to the conventional method illustrated in FIG. 3 are the six reference pixels that sandwich the Sub pels e and o and are aligned in the oblique direction in which the Sub pels e and o are aligned, as indicated by the squares surrounded by the dashed line in FIG. 8. According to the conventional method illustrated in FIG. 3, any reference pixels aligned in a direction perpendicular to the oblique direction are not used. Therefore, the characteristics of the predicted pixels in the direction perpendicular to the oblique direction in which the Sub pels e and o are aligned are poorer than those in cases where conventional interpolation filters with separable 2D structures are used.

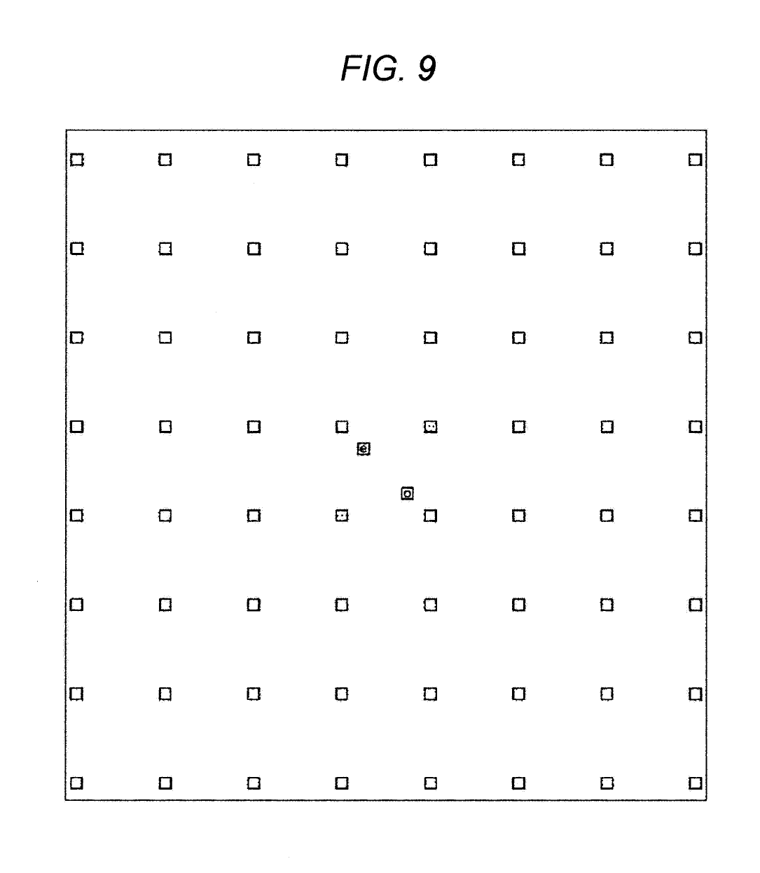

Also, as shown in FIG. 9, the two reference pixels that are the closest to the Sub pels e and o among those aligned in the direction perpendicular to the oblique direction in which the Sub pels e and o are aligned are at the same distance from the positions of the Sub pels e and o in the reference image. Accordingly, the filter coefficients for those two reference pixels are identical, by virtue of the symmetrical properties. In view of this, the FIR filter 42 shown in FIG. 5 can add up those two reference pixels, and then multiply the resultant value by the filter coefficient. As a result, the number of times a multiplication is performed can be reduced.

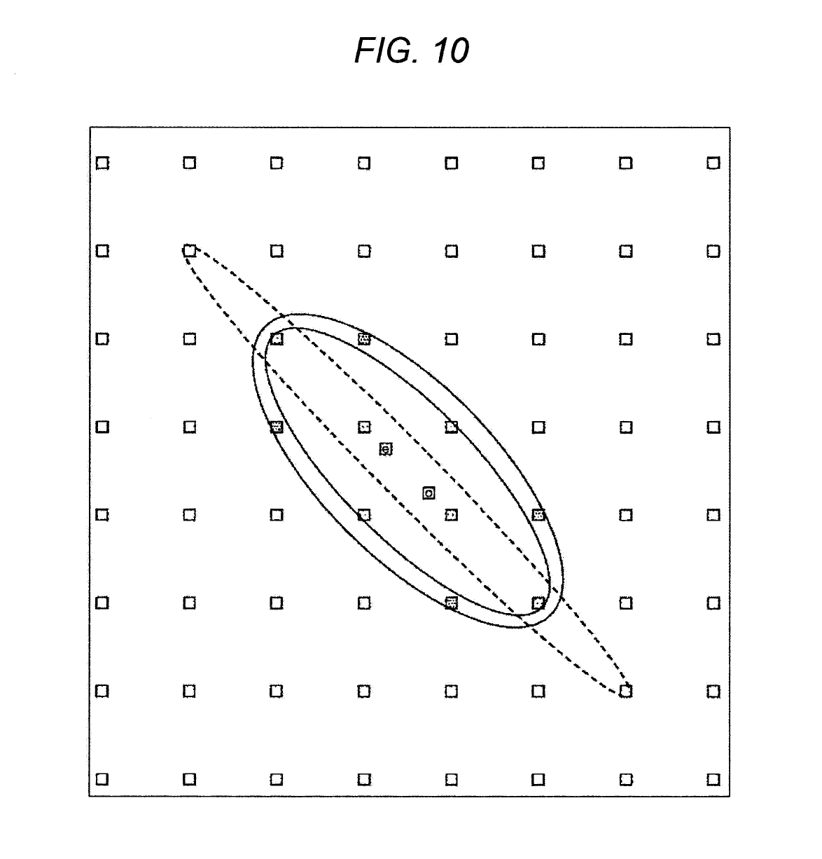

FIG. 10 is a diagram showing another example of reference pixels to be used in generating upper left and lower right predicted pixels that have ¼ pixel positions in both the horizontal direction and the vertical direction.

In the example illustrated in FIG. 10, when the predicted pixels are the upper left and lower right Sub pels e and o, which have ¼ pixel positions in both the horizontal direction and the vertical direction, the reference pixels to be used in generating the predicted pixels are the ten reference pixels represented by the dotted squares surrounded by the outer solid-line circle, which consist of the six reference pixels used in the example illustrated in FIG. 8 and the four reference pixels represented by the densely-dotted squares in FIG. 10. Specifically, the reference pixels to be used in generating the predicted pixels are the four reference pixels closest to the Sub pels e and o among those aligned in the oblique direction in which the Sub pels e and o are aligned, and a total of six reference pixels closest to the Sub pels e and o among those aligned in three directions perpendicular to the oblique direction, including two each in the three directions.

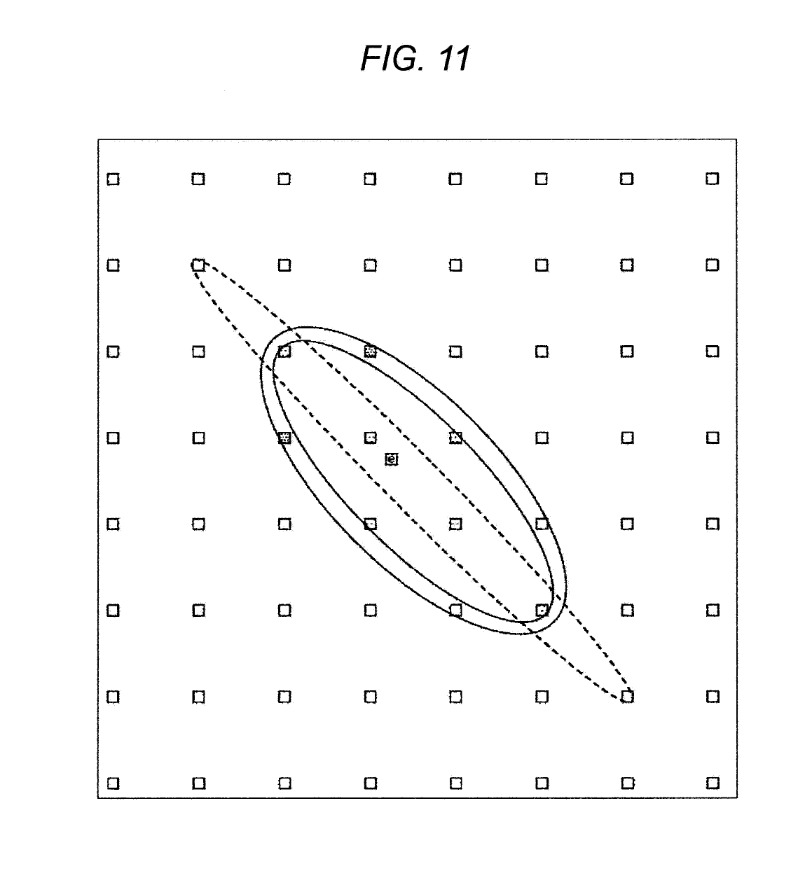

FIG. 11 is a diagram showing yet another example of reference pixels to be used in generating a predicted pixel in a case where the predicted pixel is the Sub pel e.

In the example illustrated in FIG. 11, when the predicted pixel is the Sub pel e, the reference pixels to be used in generating the predicted pixel are the eight reference pixels represented by the dotted squares surrounded by the outer solid-line circle, which consist of the six reference pixels used in the example illustrated in FIG. 8 and the two reference pixels represented by the densely-dotted squares in FIG. 11. Specifically, the reference pixels to be used in generating the predicted pixel are the four reference pixels closest to the Sub pel e among those aligned in the oblique direction in which the Sub pels e and o are aligned, and a total of four reference pixels closest to the Sub pel e among those aligned in two directions perpendicular to the oblique direction, including two each in the two directions.

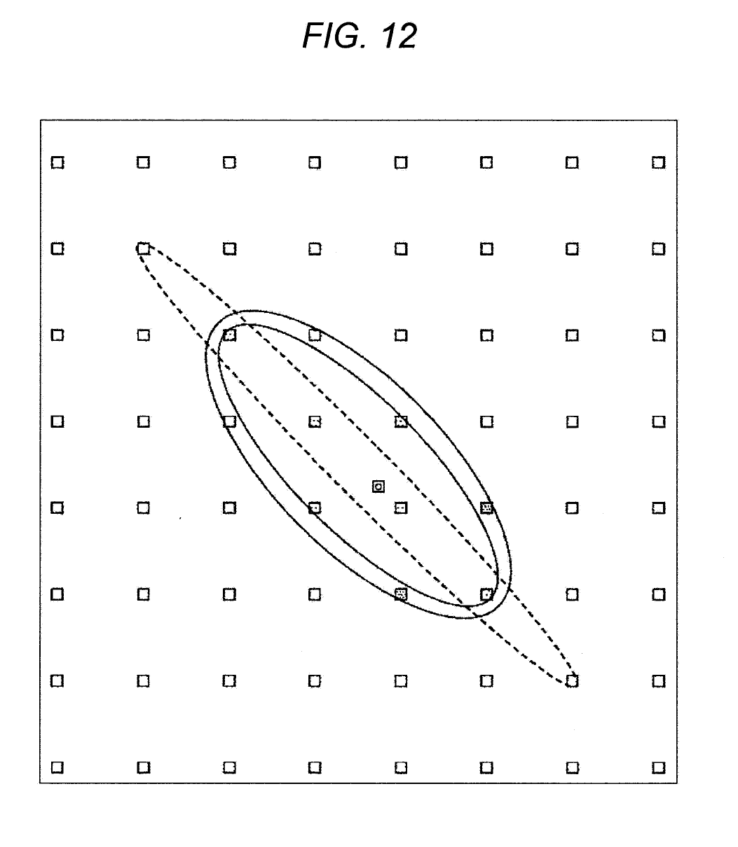

FIG. 12 is a diagram showing yet another example of reference pixels to be used in generating a predicted pixel in a case where the predicted pixel is the Sub pel o.

In the example illustrated in FIG. 12, when the predicted pixel is the Sub pel o, the reference pixels to be used in generating the predicted pixel are the eight reference pixels represented by the dotted squares surrounded by the outer solid-line circle, which consist of the six reference pixels used in the example illustrated in FIG. 8 and the two reference pixels represented by the densely-dotted squares in FIG. 12. Specifically, the reference pixels to be used in generating the predicted pixel are the four reference pixels closest to the Sub pel o among those aligned in the oblique direction in which the Sub pels e and o are aligned, and a total of four reference pixels closest to the Sub pel o among those aligned in two directions perpendicular to the oblique direction, including two each in the two directions.

Also, in a case where the FIR filter 42 performs a SIMD calculation, if the number of reference pixels to be used in generating the Sub pel e or o is eight, which is a power of 2, as shown in FIGS. 11 and 12, the calculation can be efficiently performed.

Further, the positions of the reference pixels represented by the dotted squares surrounded by the solid-lines in FIG. 8 and FIGS. 10 through 12 are closer to the Sub pels e and o, compared with the reference pixels that are to be used according to the conventional method illustrated in FIG. 3 and are represented by the squares surrounded by the dashed lines in FIG. 8 and FIGS. 10 through 12.

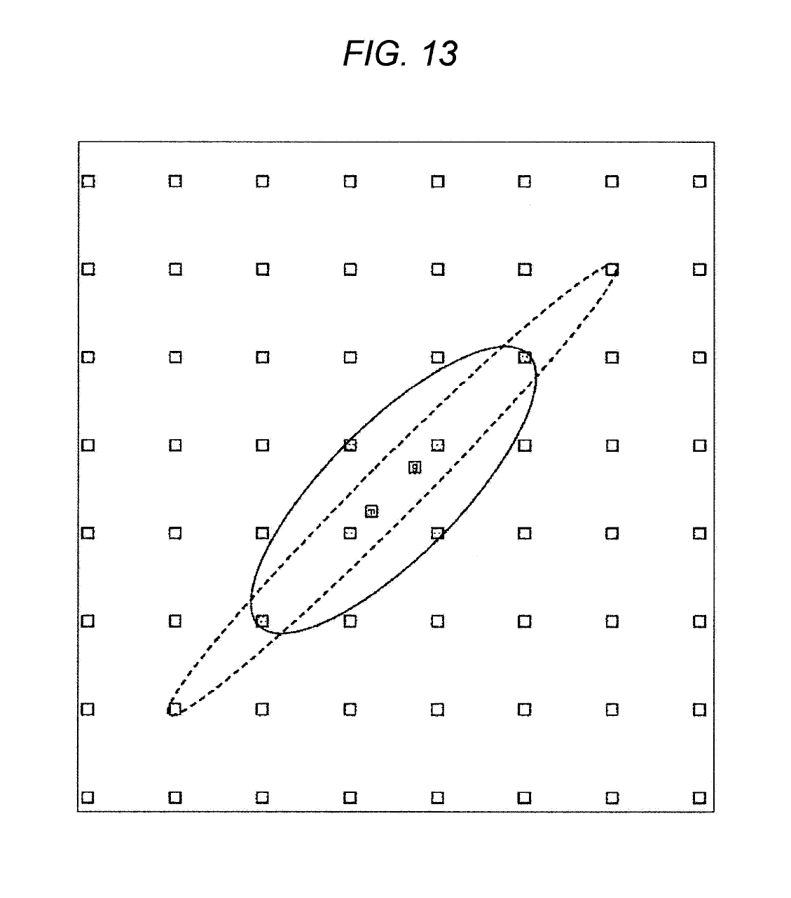

FIG. 13 is a diagram showing an example of reference pixels to be used in generating upper right and lower left predicted pixels that have ¼ pixel positions in both the horizontal direction and the vertical direction.

As shown in FIG. 13, in a case where the predicted pixels are upper right and lower left Sub pels g and m, which have ¼ pixel positions in both the horizontal direction and the vertical direction, the six reference pixels represented by the sparsely-dotted squares surrounded by the solid-line circle are used in generating the predicted pixels. Specifically, the reference pixels to be used in generating the predicted pixels are the four reference pixels closest to the Sub pels g and m among those aligned in the oblique direction in which the Sub pels g and m are aligned, and the two reference pixels closest to the Sub pels g and m among those aligned in a direction perpendicular to the oblique direction.

As described above, in the encoding device 10, when the predicted pixels are the upper right and lower left Sub pels g and m, which have ¼ pixel positions in both the horizontal direction and the vertical direction, the predicted pixels are generated by using not only reference pixels aligned in the oblique direction in which the Sub pels g and m are aligned, but also reference pixels aligned in a direction perpendicular to the oblique direction. Accordingly, the characteristics of the predicted pixels can be made desirable in the oblique direction.

On the other hand, the reference pixels to be used according to the conventional method illustrated in FIG. 3 are the six reference pixels that sandwich the Sub pels g and m and are aligned in the oblique direction in which the Sub pels g and m are aligned, as indicated by the squares surrounded by the dashed line in FIG. 13. According to the conventional method illustrated in FIG. 3, any reference pixels aligned in a direction perpendicular to the oblique direction are not used. Therefore, the characteristics of the predicted pixels in the direction perpendicular to the oblique direction in which the Sub pels g and m are aligned are poorer than those in cases where conventional interpolation filters with separable 2D structures are used.

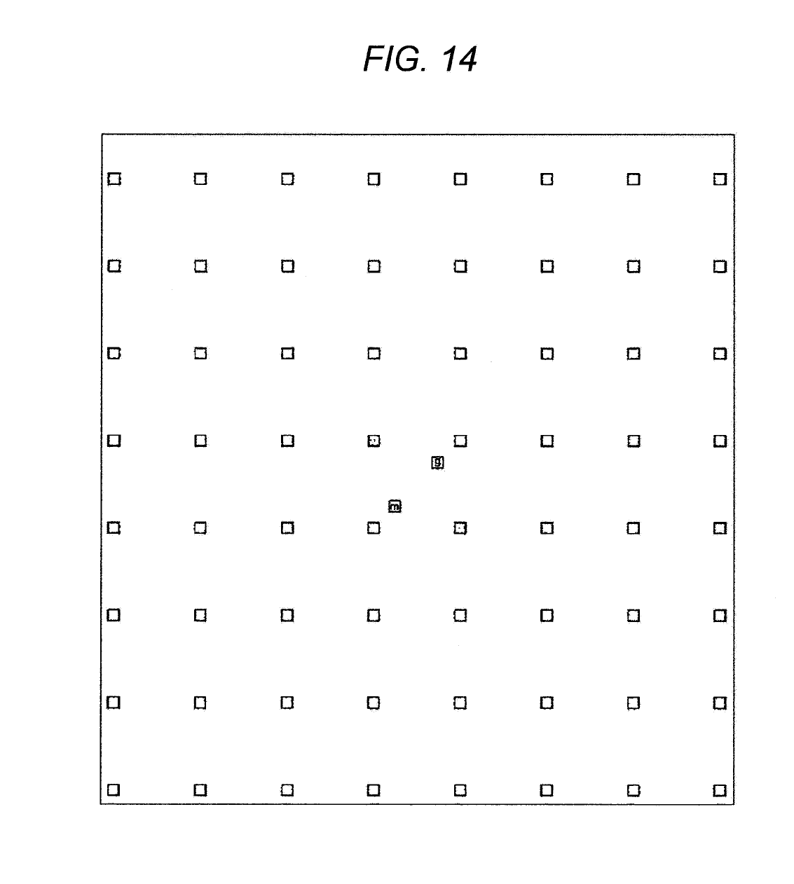

Also, as shown in FIG. 14, the two reference pixels that are the closest to the Sub pels g and m among those aligned in the direction perpendicular to the oblique direction in which the Sub pels g and m are aligned are at the same distance from the positions of the Sub pels g and m in the reference image. Accordingly, the filter coefficients for those two reference pixels are identical, by virtue of the symmetrical properties. In view of this, the FIR filter 42 can add up those two reference pixels, and then multiply the resultant value by the filter coefficient. As a result, the number of times a multiplication is performed can be reduced.

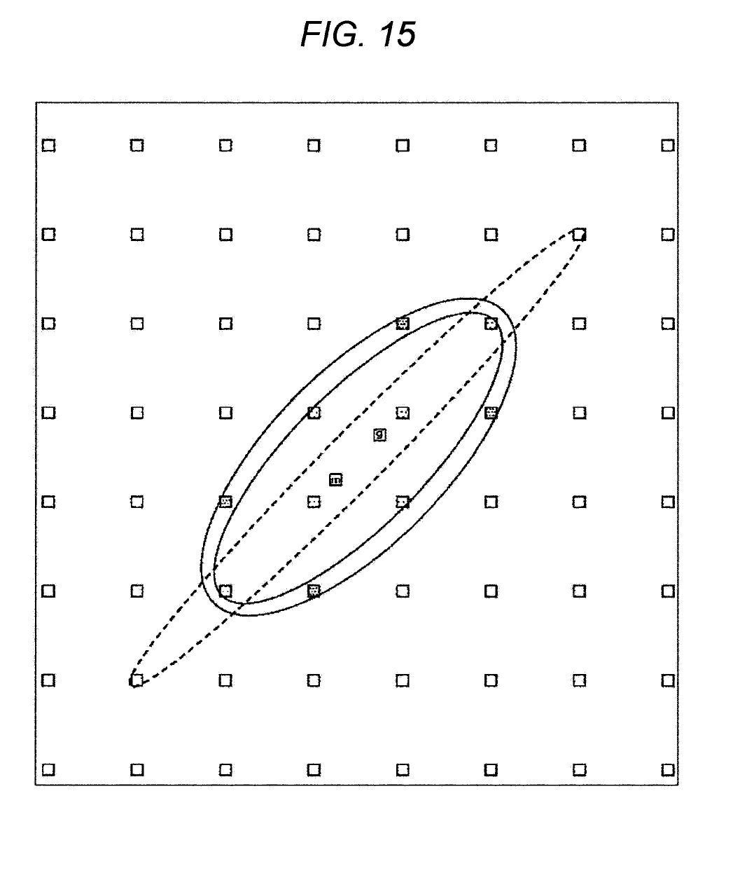

FIG. 15 is a diagram showing another example of reference pixels to be used in generating upper right and lower left predicted pixels that have ¼ pixel positions in both the horizontal direction and the vertical direction.

In the example illustrated in FIG. 15, when the predicted pixels are the upper right and lower left Sub pels g and m, which have ¼ pixel positions in both the horizontal direction and the vertical direction, the reference pixels to be used in generating the predicted pixels are the ten reference pixels represented by the dotted squares surrounded by the outer solid-line circle, which consist of the six reference pixels used in the example illustrated in FIG. 13 and the four reference pixels represented by the densely-dotted squares in FIG. 15. Specifically, the reference pixels to be used in generating the predicted pixels are the four reference pixels closest to the Sub pels g and m among those aligned in the oblique direction in which the Sub pels g and m are aligned, and a total of six reference pixels closest to the Sub pels g and m among those aligned in three directions perpendicular to the oblique direction, including two each in the three directions.

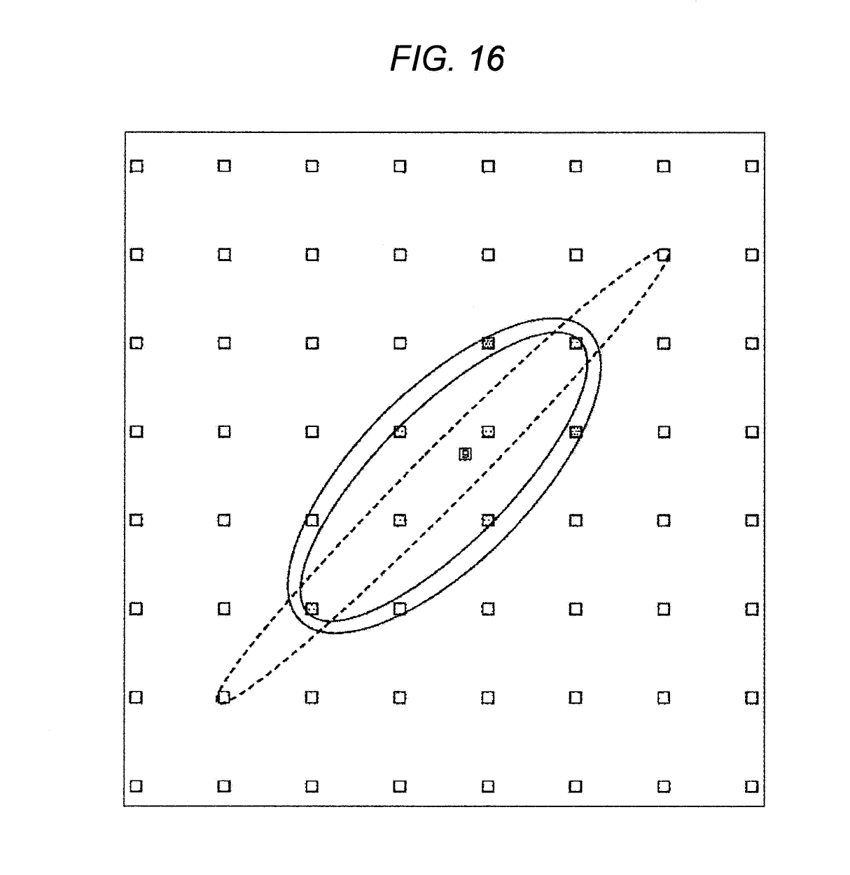

FIG. 16 is a diagram showing yet another example of reference pixels to be used in generating a predicted pixel in a case where the predicted pixel is the Sub pel g.

In the example illustrated in FIG. 16, when the predicted pixel is the Sub pel g, the reference pixels to be used in generating the predicted pixel are the eight reference pixels represented by the dotted squares surrounded by the outer solid-line circle, which consist of the six reference pixels used in the example illustrated in FIG. 13 and the two reference pixels represented by the densely-dotted squares in FIG. 16. Specifically, the reference pixels to be used in generating the predicted pixel are the four reference pixels closest to the Sub pel g among those aligned in the oblique direction in which the Sub pels g and m are aligned, and a total of four reference pixels closest to the Sub pel g among those aligned in two directions perpendicular to the oblique direction, including two each in the two directions.

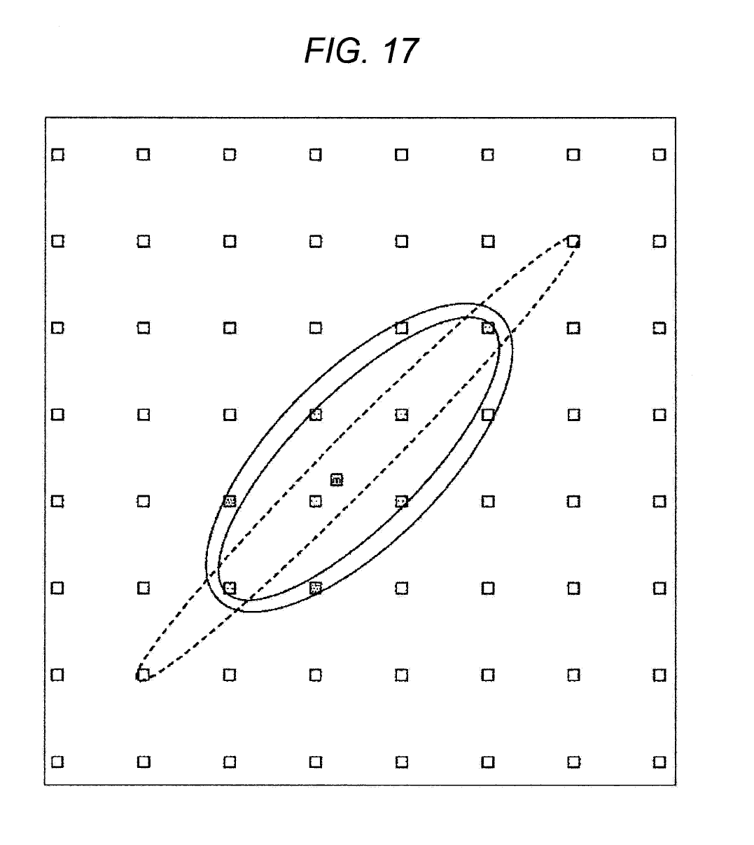

FIG. 17 is a diagram showing yet another example of reference pixels to be used in generating a predicted pixel in a case where the predicted pixel is the Sub pel m.

In the example illustrated in FIG. 17, when the predicted pixel is the Sub pel m, the reference pixels to be used in generating the predicted pixel are the eight reference pixels represented by the dotted squares surrounded by the outer solid-line circle, which consist of the six reference pixels used in the example illustrated in FIG. 13 and the two reference pixels represented by the densely-dotted squares in FIG. 17. Specifically, the reference pixels to be used in generating the predicted pixel are the four reference pixels closest to the Sub pel m among those aligned in the oblique direction in which the Sub pels g and m are aligned, and a total of four reference pixels closest to the Sub pel m among those aligned in two directions perpendicular to the oblique direction, including two each in the two directions.

In a case where the FIR filter 42 performs a SIMD calculation, if the number of reference pixels to be used in generating the Sub pel g or m is eight, which is a power of 2, as shown in FIGS. 16 and 17, the calculation can be efficiently performed.

Further, the positions of the reference pixels represented by the dotted squares surrounded by the solid-lines in FIG. 13 and FIGS. 15 through 17 are closer to the Sub pels g and m, compared with the reference pixels that are to be used according to the conventional method illustrated in FIG. 3 and are represented by the squares surrounded by the dashed lines in FIG. 13 and FIGS. 15 through 17.

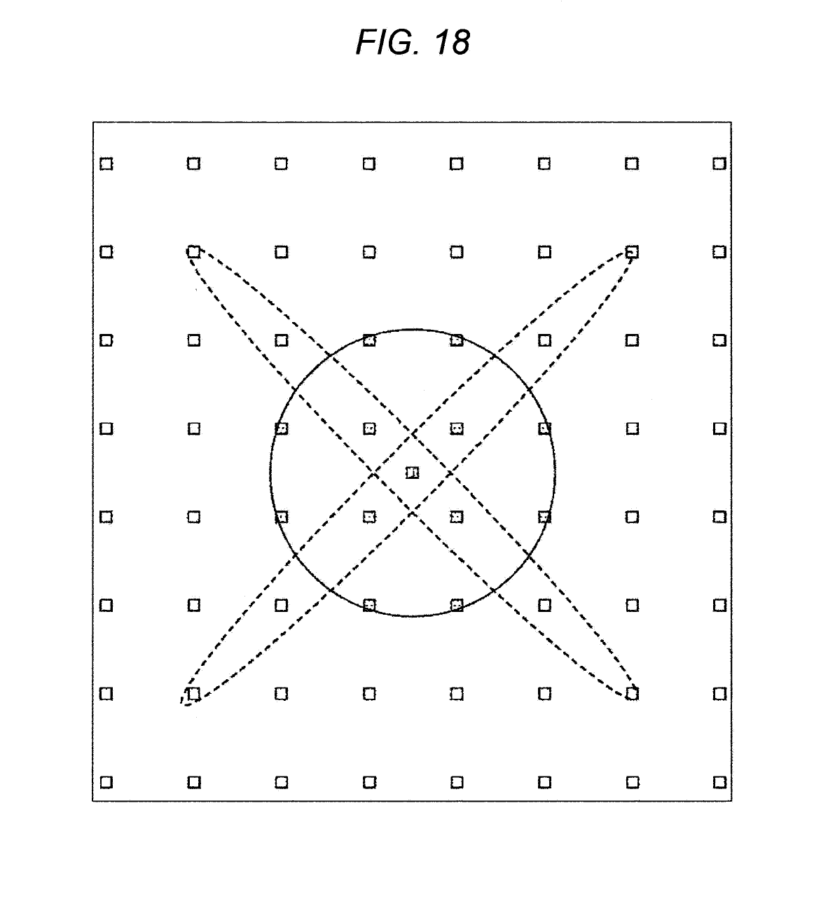

FIG. 18 is a diagram showing an example of reference pixels to be used in generating a predicted pixel that has a ½ pixel position in both the horizontal direction and the vertical direction.

As shown in FIG. 18, in a case where the predicted pixel is a Sub pel j, which has a ½ pixel position in both the horizontal direction and the vertical direction, the 12 reference pixels represented by the sparsely-dotted squares surrounded by the solid-line circle are used in generating the predicted pixel. Specifically, the reference pixels to be used in generating the predicted pixel are the eight reference pixels closest to the Sub pel j among those located on the two horizontal lines sandwiching the Sub pel j, and the four reference pixels closest, with the exception of the eight reference pixels, to the Sub pel j among those located on the two vertical lines sandwiching the Sub pel j.

As described above, in the encoding device 10, when the predicted pixel is the Sub pel j, which has a ½ pixel position in both the horizontal direction and the vertical direction, the predicted pixel is generated by using not only reference pixels aligned in two oblique directions that cross each other in the position of the Sub pel j, but also reference pixels aligned in the horizontal lines and the vertical lines sandwiching the Sub pel j. Accordingly, the characteristics of the predicted pixels can be made desirable.

On the other hand, the reference pixels to be used according to the conventional method illustrated in FIG. 3 are a total of 12 reference pixels consisting of six each aligned in the two oblique directions that cross each other in the position of the Sub pel j, as indicated by the squares surrounded by the dashed line in FIG. 18. According to the conventional method illustrated in FIG. 3, any reference pixels aligned in the horizontal direction and the vertical direction are not used. Therefore, the characteristics of the predicted pixels in the horizontal direction and the vertical direction are poorer than those in cases where conventional interpolation filters with separable 2D structures are used.

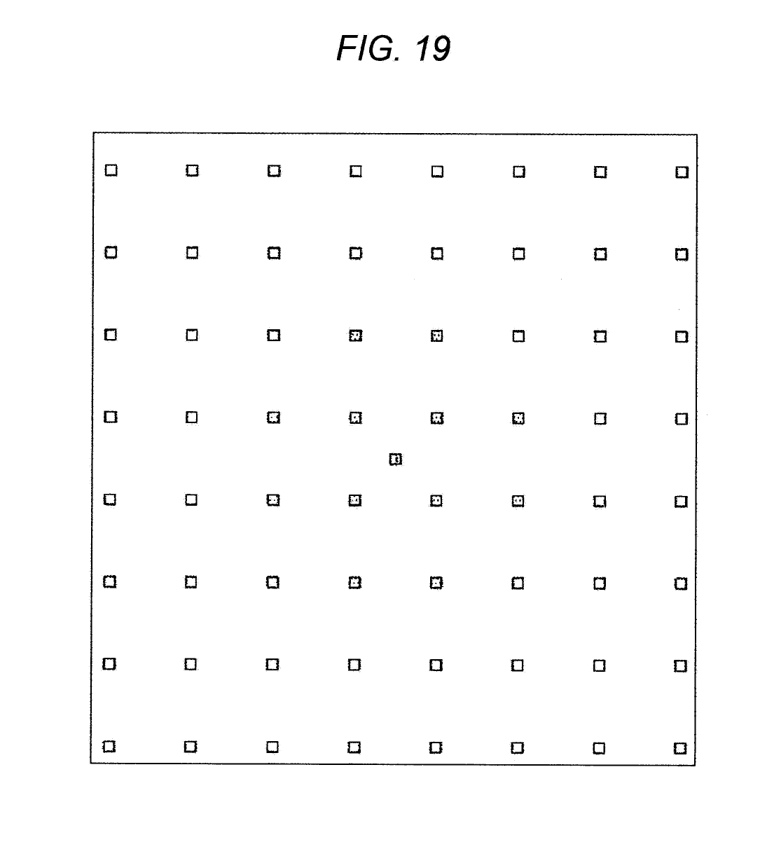

Also, as shown in FIG. 19, the 2×2 reference pixels closest to the Sub pel j are at the same distance from the position of the Sub pel j in the reference image. The eight reference pixels second closest to the Sub pel j, excluding the 2×2 reference pixels, are also at the same distance from the position of the Sub pel j in the reference image. Accordingly, the filter coefficients for the 2×2 reference pixels are identical, and the filter coefficients for the eight reference pixels, excluding the 2×2 reference pixels, are identical, by virtue of the symmetrical properties. In view of this, the FIR filter 42 can add up the 2×2 reference pixels, and then multiply the resultant value by the corresponding filter coefficient. The FIR filter 42 can also add up the eight reference pixels, excluding the 2×2 reference pixels, and then multiply the resultant value by the corresponding filter coefficient. As a result, the number of times a multiplication is performed can be reduced.

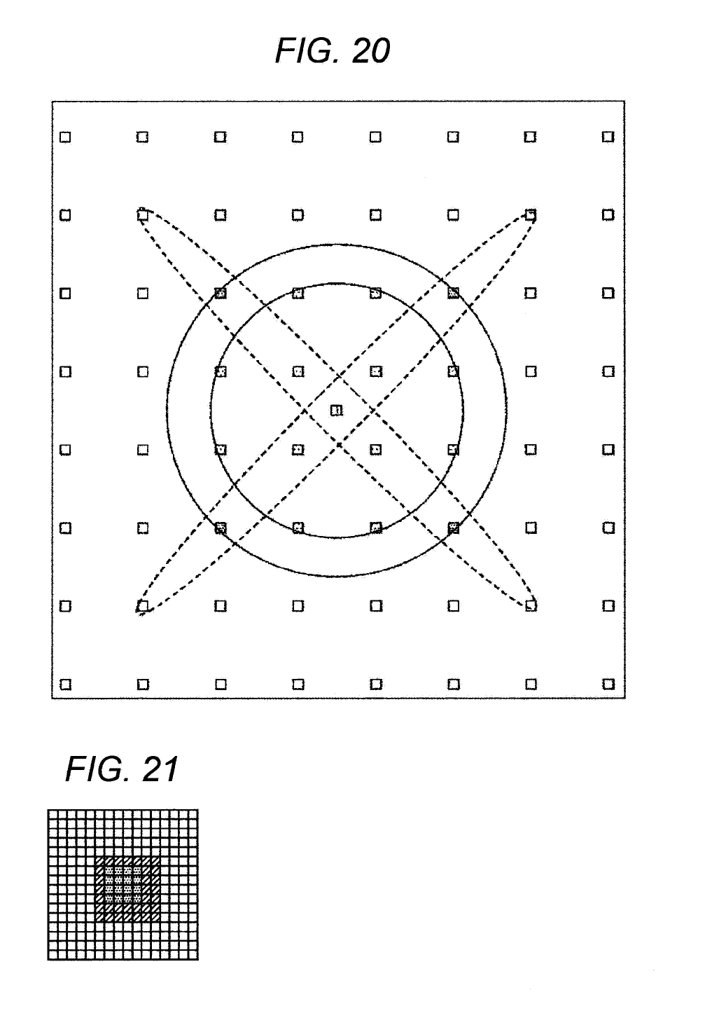

FIG. 20 is a diagram showing another example of reference pixels to be used in generating a predicted pixel that has a ½ pixel position in both the horizontal direction and the vertical direction.

In the example illustrated in FIG. 20, when the predicted pixel is the Sub pel j, which has a ½ pixel position in both the horizontal direction and the vertical direction, the 16 reference pixels represented by the dotted squares surrounded by the outer solid-line circle are used in generating the predicted pixel. The 16 reference pixels consist of the 12 reference pixels used in the example illustrated in FIG. 18, and the four reference pixels represented by the densely-dotted squares in FIG. 20. Specifically, the 4×4 reference pixels around the Sub pel j are used in generating the predicted pixel.

In a case where the FIR filter 42 performs a SIMD calculation, if the number of reference pixels to be used in generating the Sub pel j is 16, which is a power of 2, as shown in FIG. 20, the calculation can be efficiently performed.

Also, the positions of the reference pixels represented by the dotted squares surrounded by the solid-lines in FIGS. 18 and 20 are closer to the Sub pel j, compared with the reference pixels that are to be used according to the conventional method illustrated in FIG. 3 and are represented by the squares surrounded by the dashed lines in FIGS. 18 and 20.

FIG. 21 is a diagram showing an example of reference pixels necessary for generating predicted pixels in arbitrary fractional positions in a case where the block size of the inter prediction block is 4×4 pixels.

In FIG. 21, each square represents a reference pixel. Each dotted square represents a reference pixel located within the range of the size of the inter prediction block among the reference pixels to be used in generating the predicted pixels, and each shaded square represents a reference pixel outside the range of the size of the inter prediction block.

In the example illustrated in FIG. 21, the Sub pels a through e, g, h, j, l, m, and o are generated by using the reference pixels described with reference to FIGS. 6 through 20, and Sub pels f, i, k, and n are generated by using the adjacent Sub pels.

In this case, the reference pixel range necessary for generating the predicted pixels in arbitrary fractional positions is the range of 7×7 pixels consisting of the range of 4×4 pixels, which is the size of the inter prediction block, the one column and the one row of pixels to the immediate left of and immediately above the 4×4 pixel range, and the two columns and the two rows of pixels to the immediate right of and immediately below the 4×4 pixel range, as shown in FIG. 21.

As described above, the reference pixels described with reference to FIGS. 6 through 20 are located closer to the predicted pixels, compared with the reference pixels to be used according to the conventional method illustrated in FIG. 3. Accordingly, the number of reference pixels necessary for generating the predicted pixels in arbitrary fractional positions is smaller than that in the case where the conventional method illustrated in FIG. 3 is used. As a result, usage of memory bandwidth in the frame memory 22 can be reduced.

In a case where the conventional method illustrated in FIG. 3 is used, the reference pixel range necessary for generating the predicted pixels in arbitrary fractional positions is a range of 9×9 pixels, as in the case illustrated in FIG. 2. Moreover, in practice, it is difficult to access the frame memory pixel by pixel, and therefore, usage of memory bandwidth is larger than 9×9 pixels.

### Examples of Filter Coefficients

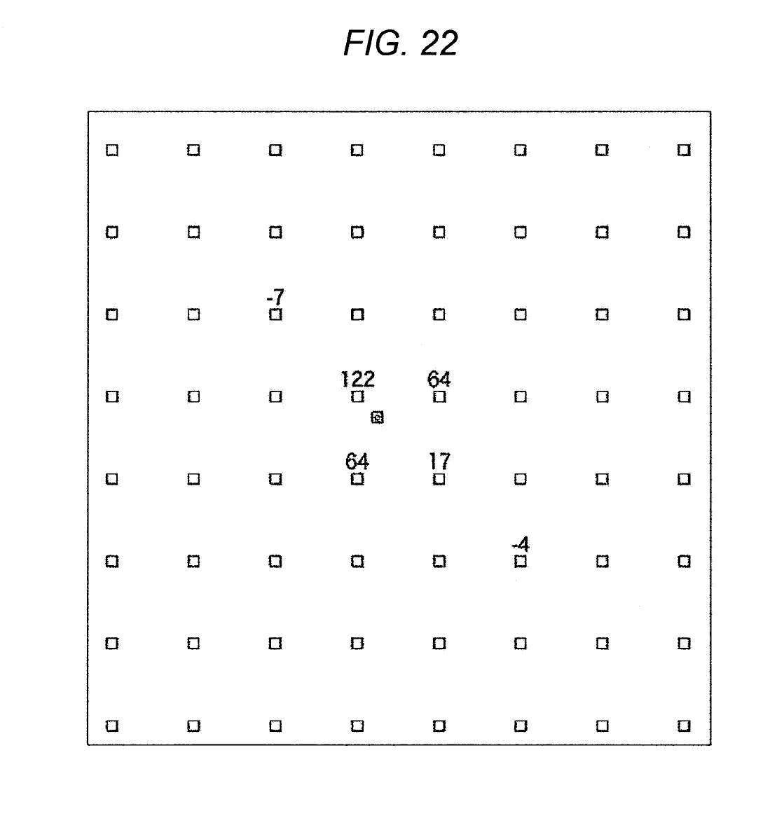

FIGS. 22 through 26 are diagrams showing examples of filter coefficients stored in the FIR filter 42 shown in FIG. 5.

As shown in FIG. 22, the filter coefficients to be used in generating a predicted pixel that is the Sub pel e are, in descending order, the filter coefficient for the closest reference pixel (hereinafter referred to as the nearest reference pixel), the filter coefficients for the reference pixel to the immediate right of the nearest reference pixel and the reference pixel immediately below the nearest reference pixel, the filter coefficient for the reference pixel to the lower right of the nearest reference pixel, the filter coefficient for the reference pixel to the lower right of the lower right reference pixel, and the filter coefficient for the reference pixel to the upper left of the nearest reference pixel. In the example illustrated in FIG. 22, the filter coefficient for the nearest reference pixel is 122, and the filter coefficients for the reference pixel to the immediate right of the nearest reference pixel and the reference pixel immediately below the nearest reference pixel are 64. The filter coefficient for the reference pixel to the lower right of the nearest reference pixel is 17, the filter coefficient for the reference pixel to the lower right of the lower right pixel is −4, and the filter coefficient for the reference pixel to the upper left of the nearest reference pixel is −7.

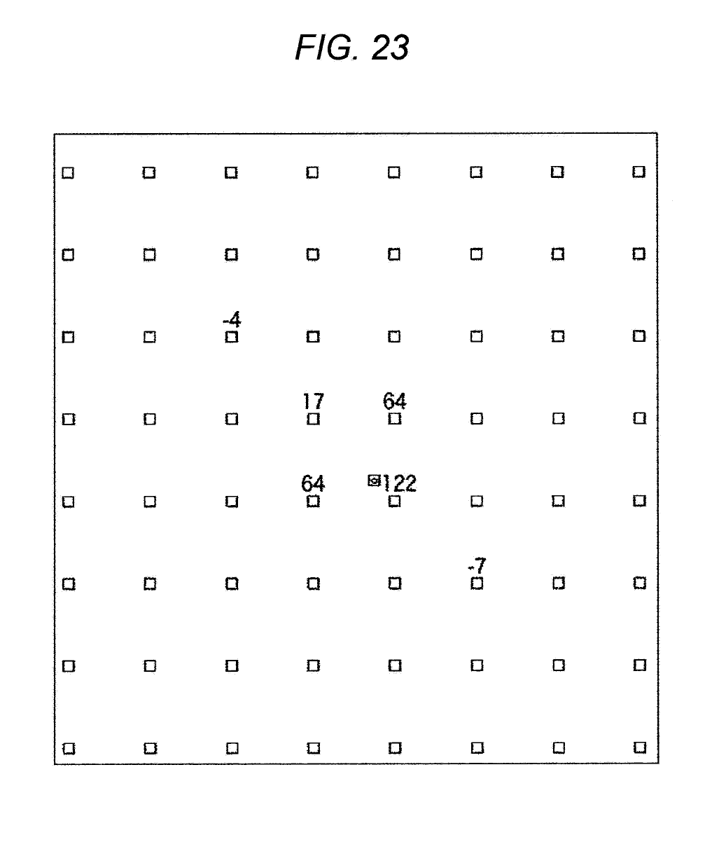

As shown in FIG. 23, the filter coefficients to be used in generating a predicted pixel that is the Sub pel are, in descending order, the filter coefficient for the nearest reference pixel, the filter coefficients for the reference pixel to the immediate left of the nearest reference pixel and the reference pixel immediately above the nearest reference pixel, the filter coefficient for the reference pixel to the upper left of the nearest reference pixel, the filter coefficient for the reference pixel to the upper left of the upper left reference pixel, and the filter coefficient for the reference pixel to the lower right of the nearest reference pixel. In the example illustrated in FIG. 23, the filter coefficient for the nearest reference pixel is 122, and the filter coefficients for the reference pixel to the immediate left of the nearest reference pixel and the reference pixel immediately above the nearest reference pixel are 64. The filter coefficient for the reference pixel to the upper left of the nearest reference pixel is 17, the filter coefficient for the reference pixel to the upper left of the upper left pixel is −4, and the filter coefficient for the reference pixel to the lower right of the nearest reference pixel is −7.

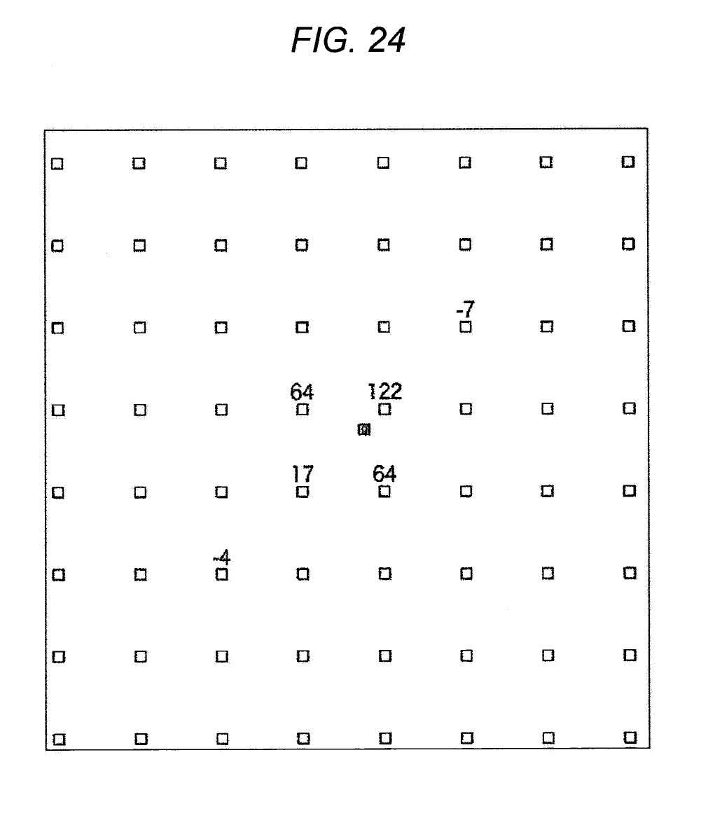

As shown in FIG. 24, the filter coefficients to be used in generating a predicted pixel that is the Sub pel g are, in descending order, the filter coefficient for the nearest reference pixel, the filter coefficients for the reference pixel to the immediate left of the nearest reference pixel and the reference pixel immediately below the nearest reference pixel, the filter coefficient for the reference pixel to the lower left of the nearest reference pixel, the filter coefficient for the reference pixel to the lower left of the lower left reference pixel, and the filter coefficient for the reference pixel to the upper right of the nearest reference pixel. In the example illustrated in FIG. 24, the filter coefficient for the nearest reference pixel is 122, and the filter coefficients for the reference pixel to the immediate left of the nearest reference pixel and the reference pixel immediately below the nearest reference pixel are 64. The filter coefficient for the reference pixel to the lower left of the nearest reference pixel is 17, the filter coefficient for the reference pixel to the lower left of the lower left pixel is −4, and the filter coefficient for the reference pixel to the upper right of the nearest reference pixel is −7.

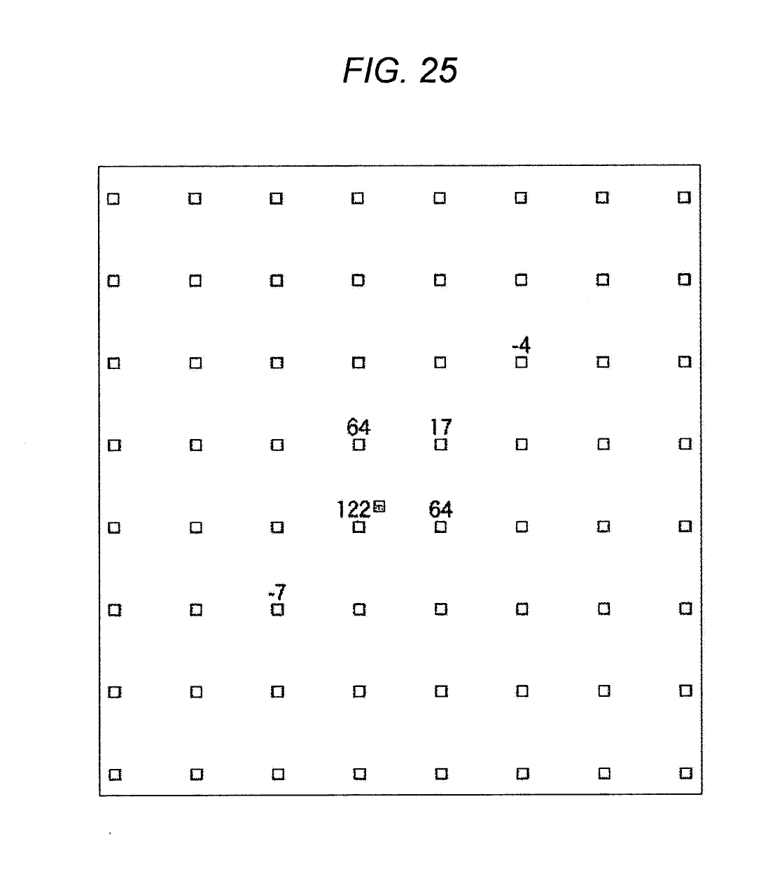

As shown in FIG. 25, the filter coefficients to be used in generating a predicted pixel that is the Sub pel m are, in descending order, the filter coefficient for the nearest reference pixel, the filter coefficients for the reference pixel to the immediate right of the nearest reference pixel and the reference pixel immediately above the nearest reference pixel, the filter coefficient for the reference pixel to the upper right of the nearest reference pixel, the filter coefficient for the reference pixel to the upper right of the upper right reference pixel, and the filter coefficient for the reference pixel to the lower left of the nearest reference pixel. In the example illustrated in FIG. 25, the filter coefficient for the nearest reference pixel is 122, and the filter coefficients for the reference pixel to the immediate right of the nearest reference pixel and the reference pixel immediately above the nearest reference pixel are 64. The filter coefficient for the reference pixel to the upper right of the nearest reference pixel is 17, the filter coefficient for the reference pixel to the upper right of the upper right pixel is −4, and the filter coefficient for the reference pixel to the lower left of the nearest reference pixel is −7.

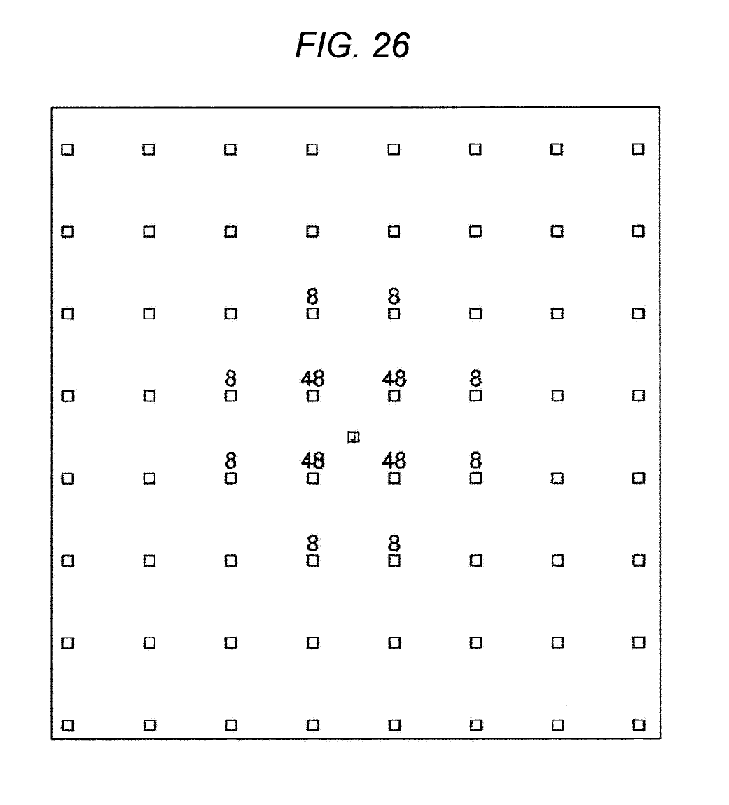

As shown in FIG. 26, the filter coefficients to be used in generating a predicted pixel that is the Sub pel j are larger in positions closer to the Sub pel j. Specifically, those filter coefficients in descending order are the filter coefficients for the nearest reference pixels and the filter coefficients for the other reference pixels. In the example illustrated in FIG. 22, the filter coefficients for the nearest reference pixels are 48, and the filter coefficients for the other reference pixels are 8.

To simplify the calculations to be performed by the FIR filter 42, the filter coefficients shown in FIGS. 22 through 26 are 256 times the actual filter coefficients, Therefore, in a case where the filter coefficients shown in FIGS. 22 through 26 are stored in the filter coefficient memory 43, the FIR filter 42 multiplies the filter coefficient for each reference pixel by the reference pixel, adds the multiplication result to an offset value, and divides the resultant value by 256, according to the following formula (3):

$$\begin{matrix}[ Mathematical Formula 1 ] & \\ \begin{matrix}Y = \frac{( ( {\sum }_{i = 0}^{5} {h}_{i} {P}_{i} ) + 128 )}{256} \\ = ( ( {\sum }_{i = 0}^{5} {h}_{i} {P}_{i} ) + 128 ) >> 8\end{matrix} & ( 3 )\end{matrix}$$

In the formula (3), Y represents the predicted pixel, hᵢ represents the filter coefficient for the ith reference pixel, and Pᵢ represents the ith reference pixel. Meanwhile, 128 is the offset value.

### Description of an Operation of the Encoding Device

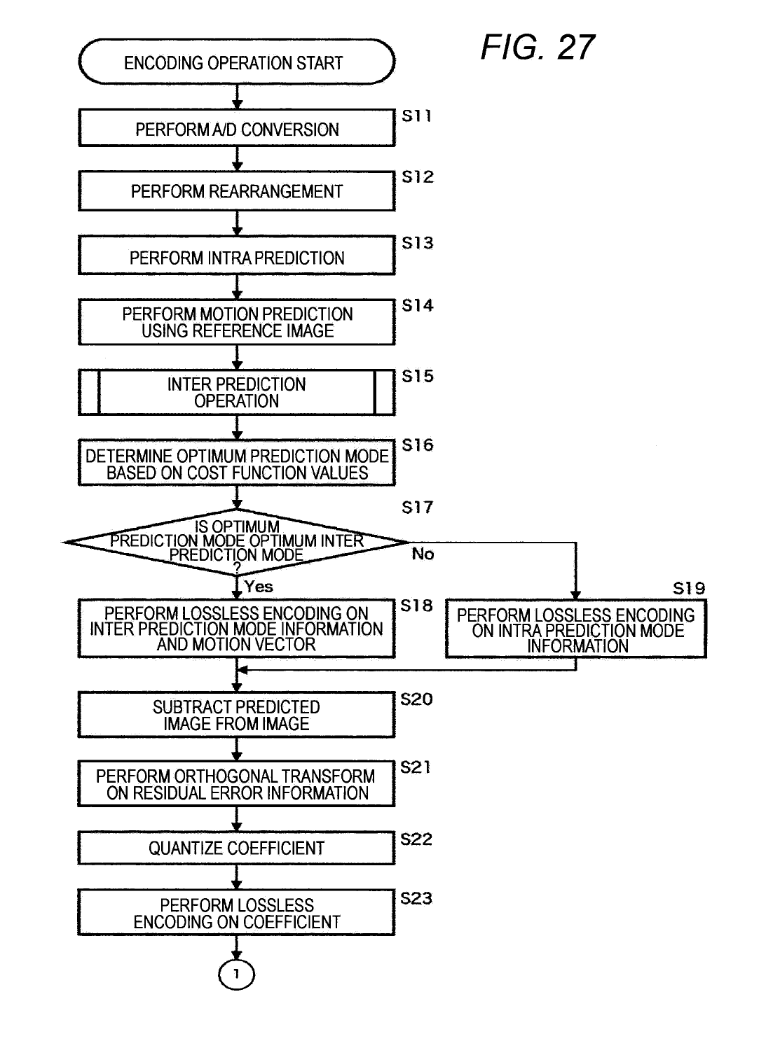

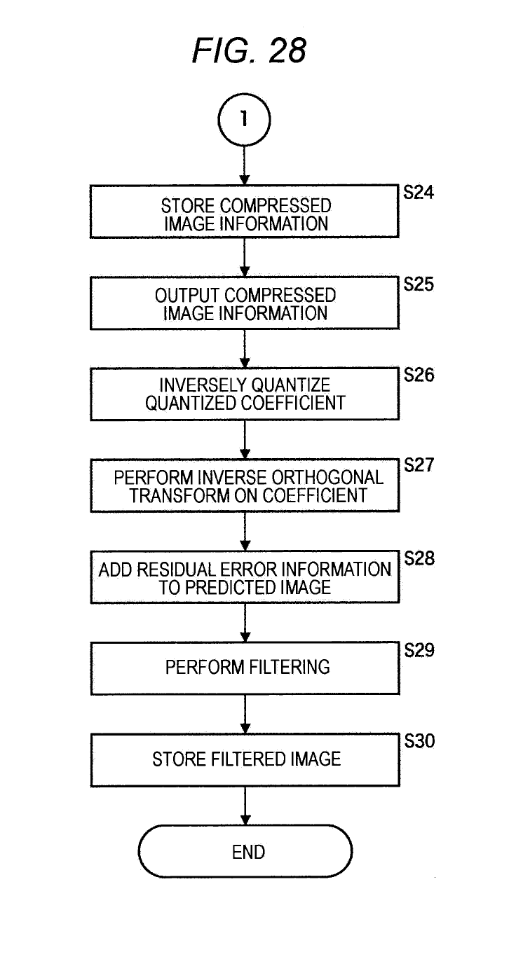

FIGS. 27 and 28 show a flowchart for explaining an encoding operation by the encoding device 10 shown in FIG. 4. This encoding operation is performed every time a frame-based image is input as an input signal to the encoding device 10, for example.

In step S11 of FIG. 27, the A/D converter 11 of the encoding device 10 performs an A/D conversion on a frame-based image input as an input signal, and outputs and stores the image into the screen rearrangement buffer 12.

In step S12, the screen rearrangement buffer 12 rearranges the frames of the image stored in displaying order, so that the frames of the image are arranged in encoding order in accordance with the GOP (Group of Pictures) structure. The screen rearrangement buffer 12 supplies the rearranged frame-based image to the arithmetic operation unit 13, the intra prediction unit 23, and the motion prediction unit 25.

It should be noted that the procedures of steps S13 through S30 described below are carried out for each macroblock, for example. When the first macroblock of the first frame is processed, however, there exist no reference pixels. Therefore, the procedures of steps S13 through S20 and S28 are not carried out, and the image of the first frame is set as residual error information and a locally decoded image.

In step S13, based on the image supplied from the screen rearrangement buffer 12 and a reference image supplied from the addition unit 20, the intra prediction unit 23 performs intra predictions in all candidate intra prediction modes, and generates predicted images. The intra prediction unit 23 also calculates cost function values for all the candidate intra prediction modes. The intra prediction unit 23 then determines the intra prediction mode with the smallest cost function value to be an optimum intra prediction mode. The intra prediction unit 23 supplies the predicted image generated in the optimum intra prediction mode and the corresponding cost function value to the selection unit 26.

In step S14, the motion prediction unit 25 performs a motion prediction operation on the image supplied from the screen rearrangement buffer 12 in all candidate inter prediction modes by using a reference image supplied from the frame memory 22, and generates motion vectors with fractional precision. The motion prediction unit 25 also calculates cost function values for all the candidate inter prediction modes, and determines the inter prediction mode with the smallest cost function value to be an optimum inter prediction mode. The motion prediction unit 25 then supplies the inter prediction mode information, the corresponding motion vector, and the corresponding cost function value to the inter prediction unit 24.

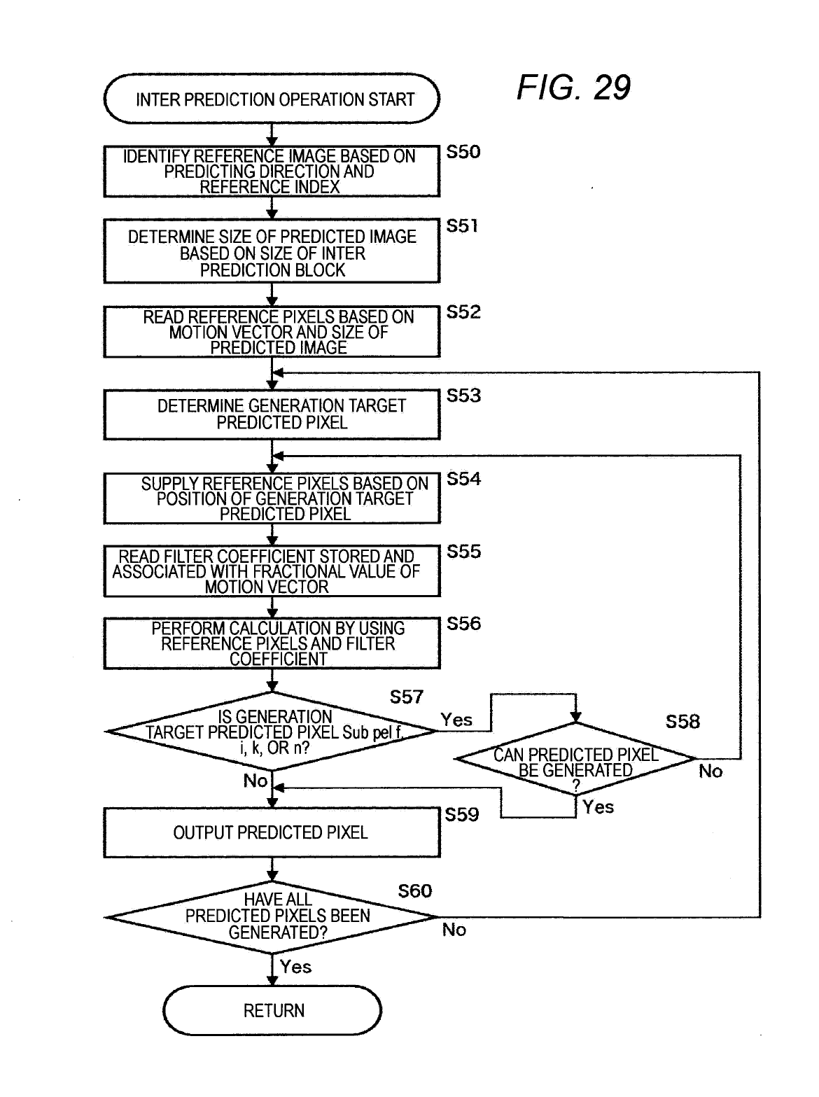

In step S15, the inter prediction unit 24 performs an inter prediction operation, based on the motion vector and the inter prediction mode information supplied from the motion prediction unit 25. This inter prediction operation will be described later in detail, with reference to FIG. 29. The inter prediction unit 24 supplies the predicted image generated as a result of the inter prediction operation and the cost function value supplied from the motion prediction unit 25, to the selection unit 26.

In step S16, based on the cost function values supplied from the intra prediction unit 23 and the inter prediction unit 24, the selection unit 26 determines an optimum prediction mode that is the optimum intra prediction mode or the optimum inter prediction mode, whichever has the smallest cost function value. The selection unit 26 then supplies the predicted image in the optimum prediction mode to the arithmetic operation unit 13 and the addition unit 20.

In step S17, the selection unit 26 determines whether the optimum prediction mode is the optimum inter prediction mode. If the optimum prediction mode is determined to be the optimum inter prediction mode in step S17, the selection unit 26 notifies the inter prediction unit 24 of selection of the predicted image generated in the optimum inter prediction mode. The inter prediction unit 24 then outputs the inter prediction mode information, the corresponding motion vector, and the like to the lossless encoding unit 16.

In step S18, the lossless encoding unit 16 performs lossless encoding on the inter prediction mode information, the motion vector, and the like supplied from the inter prediction unit 24, and sets the resultant information as the header information to be added to a compressed image. The operation then moves on to step S20.

If the optimum prediction mode is determined not to be the optimum inter prediction mode in step S17, or if the optimum prediction mode is determined to be the optimum intra prediction mode, on the other hand, the selection unit 26 notifies the intra prediction unit 23 of selection of the predicted image generated in the optimum intra prediction mode. Accordingly, the intra prediction unit 23 supplies the intra prediction mode information to the lossless encoding unit 16.

In step S19, the lossless encoding unit 16 performs lossless encoding on the intra prediction mode information and the like supplied from the intra prediction unit 23, and sets the resultant information as the header information to be added to the compressed image. The operation then moves on to step S20.

In step S20, the arithmetic operation unit 13 subtracts the predicted image supplied from the selection unit 26, from the image supplied from the screen rearrangement buffer 12. The arithmetic operation unit 13 outputs the image obtained as a result of the subtraction, as residual error information to the orthogonal transform unit 14.

In step S21, the orthogonal transform unit 14 performs an orthogonal transform on the residual error information supplied from the arithmetic operation unit 13, and supplies the resultant coefficients to the quantization unit 15.

In step S22, the quantization unit 15 quantizes the coefficients supplied from the orthogonal transform unit 14. The quantized coefficients are input to the lossless encoding unit 16 and the inverse quantization unit 18.

In step S23, the lossless encoding unit 16 performs lossless encoding on the quantized coefficients supplied from the quantization unit 15, and sets the resultant information as the compressed image. The lossless encoding unit 16 then adds the header information generated through the procedure of step S18 or S19 to the compressed image, to generate compressed image information.

In step S24 of FIG. 28, the lossless encoding unit 16 supplies and stores the compressed image information into the accumulation buffer 17.

In step S25, the accumulation buffer 17 outputs the stored compressed image information to a recording device, a transmission path, or the like (not shown) in a later stage, for example.

In step S26, the inverse quantization unit 18 inversely quantizes the quantized coefficients supplied from the quantization unit 15.

In step S27, the inverse orthogonal transform unit 19 performs an inverse orthogonal transform on the coefficients supplied from the inverse quantization unit 18, and supplies the resultant residual error information to the addition unit 20.

In step S28, the addition unit 20 adds the residual error information supplied from the inverse orthogonal transform unit 19 to the predicted image supplied from the selection unit 26, and obtains a locally decoded image. The addition unit 20 supplies the obtained image to the deblocking filter 21, and also supplies the obtained image as a reference image to the intra prediction unit 23.

In step S29, the deblocking filter 21 performs filtering on the locally decoded image supplied from the addition unit 20, to remove block distortions.

In step S30, the deblocking filter 21 supplies and stores the filtered image into the frame memory 22. The image stored in the frame memory 22 is then output as a reference image to the inter prediction unit 24 and the motion prediction unit 25. The operation then comes to an end.

FIG. 29 is a flowchart for explaining, in detail, the inter prediction operation of step S15 of FIG. 27.

In step S50 of FIG. 29, the reference image read unit 41 (FIG. 5) of the inter prediction unit 24 identifies the reference image among the images stored in the frame memory 22, based on the predicting direction and the reference index contained in the inter prediction mode information supplied from the motion prediction unit 25 shown in FIG. 4.

In step S51, the reference image read unit 41 determines the size of a predicted image, based on the inter prediction block size contained in the inter prediction mode information.

In step S52, based on the integer value of the motion vector contained in the inter prediction mode information and the size of the predicted image, the reference image read unit 41 reads, from the frame memory 22, the reference pixels to be used in generating the predicted image, and temporarily stores those reference pixels.

In step S53, the reference image read unit 41 determines a generation target predicted pixel among the predicted pixels forming the predicted image. The determined generation target predicted pixel is a predicted pixel that has not yet been determined to be a generation target predicted pixel in the procedure of step S53.

In step S54, based on the position of the generation target predicted pixel in the reference image, the reference image read unit 41 reads the reference pixels to be used in generating the predicted pixel among the reference pixels read in step S52, and supplies the reference pixels to the FIR filter 42.

In step S55, based on the fractional value of the motion vector supplied from the motion prediction unit 25 shown in FIG. 4, the filter coefficient memory 43 supplies the filter coefficients stored and associated with the fractional value, to the FIR filter 42.

In step S56, the FIR filter 42 performs a calculation by using the reference pixels supplied from the reference image read unit 41 and the filter coefficients.

In step S57, the FIR filter 42 determines whether the generation target predicted pixel is a Sub pel f, k, or n. If the generation target predicted pixel is determined to be a Sub pel f, i, k, or n in step S57, the operation moves on to step S58.

In step S58, the FIR filter 42 determines whether the generation target predicted pixel is generable, or whether all the Sub pels to be used in generating the generation target predicted pixel have been generated.

If the generation target predicted pixel is determined not to be generable in step S58, the operation returns to step S54, and the procedures of steps S54 through S58 are repeated until the generation target predicted pixel becomes generable.

If the generation target predicted pixel is determined to be generable in step S58, on the other hand, the FIR filter 42 performed a predetermined calculation by using the pixels obtained as a result of the calculation in step S56, and generates the predicted pixel. The operation then moves on to step S59.

If the generation target predicted pixel is determined not to be a Sub pel f, i, k, or n in step S57, the operation moves on to step S59.

In step S59, the FIR filter 42 outputs the predicted pixel generated through the procedure of step S58 to the selection unit 26, or outputs the one pixel obtained as a result of the calculation in step S56 as the predicted pixel.

In step S60, the reference image read unit 41 determines whether all the predicted pixels have been generated, or whether all the predicted pixels forming the predicted image have been determined to be generation target predicted pixels in step S53. If it is determined in step S60 that not all the predicted pixels have been generated, the operation returns to step S53, and the procedures of steps S53 through S59 are repeated until all the predicted pixels have been generated.

If it is determined in step S60 that all the predicted pixels have been generated, on the other hand, the operation returns to step S15 of FIG. 27, and then moves on to step S16.

As described above, when the predicted pixel has a fractional position that is not a ½ pixel position in the horizontal direction and the vertical direction in the reference image in an inter prediction, the encoding device 10 generates the predicted pixel by using reference pixels that are aligned in two directions perpendicular to each other. For example, the encoding device 10 generates a predicted pixel that is a Sub pel e, o, g, or m by using reference pixels aligned in two oblique directions perpendicular to each other.

Accordingly, processing loads and delays are made smaller than those in cases where interpolation filters with conventional separable 2D structures are used. Further, the characteristics of the predicted pixel in one of the two oblique directions perpendicular to each other are improved, compared with the conventional method illustrated in FIG. 3. That is, the encoding device 10 can reduce processing loads and delays in inter predictions while suppressing decreases in inter prediction precision.

### Example Structure of a Decoding Device

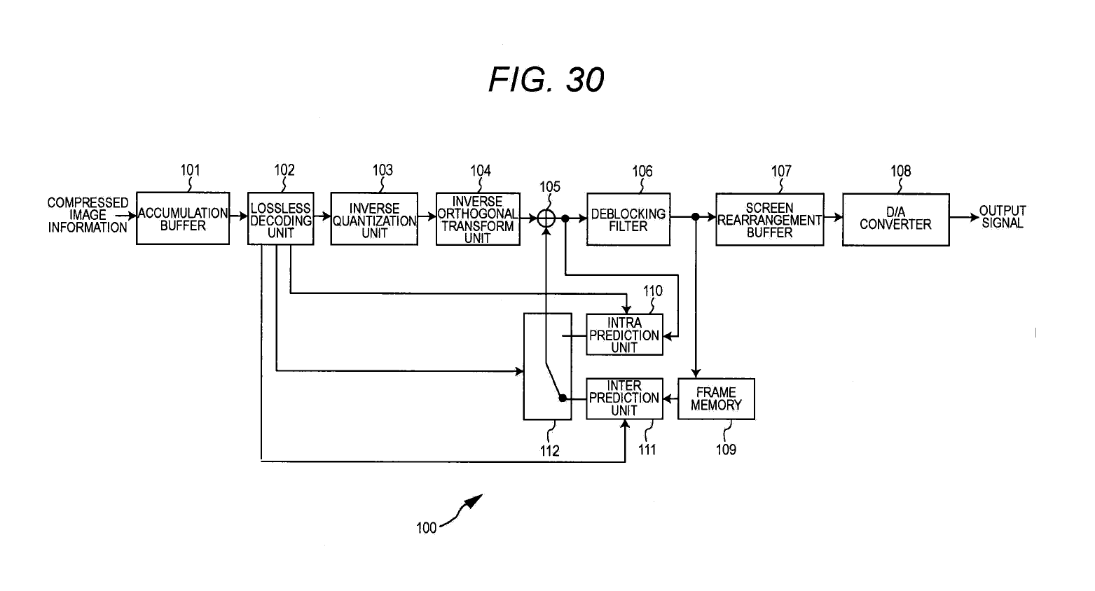

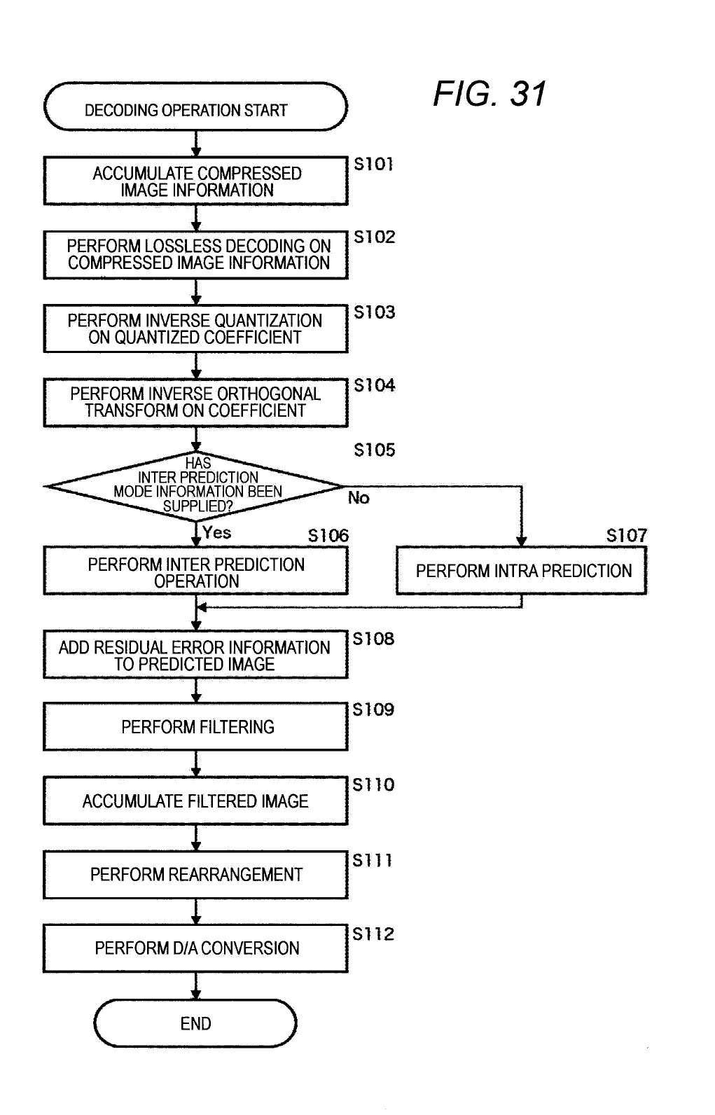

FIG. 30 is a block diagram showing an example structure of a decoding device as an image processing device to which the present invention is applied. This decoding device decodes compressed image information that is output from the encoding device 10 shown in FIG. 4.

The decoding device 100 shown in FIG. 30 includes an accumulation buffer 101, a lossless decoding unit 102, an inverse quantization unit 103, an inverse orthogonal transform unit 104, an addition unit 105, a deblocking filter 106, a screen rearrangement buffer 107, a D/A converter 108, a frame memory 109, an intra prediction unit 110, an inter prediction unit 111, and a switch 112.

The accumulation buffer 101 of the decoding device 100 receives and accumulates compressed image information from the encoding device 10 shown in FIG. 4. The accumulation buffer 101 supplies the accumulated compressed image information to the lossless decoding unit 102.

The lossless decoding unit 102 obtains quantized coefficients and a header by performing lossless decoding such as variable-length decoding or arithmetic decoding on the compressed image information supplied from the accumulation buffer 101. The lossless decoding unit 102 supplies the quantized coefficients to the inverse quantization unit 103. The lossless decoding unit 102 also supplies intra prediction mode information and the like contained in the header to the intra prediction unit 110, and supplies the motion vector, inter prediction mode information, and the like to the inter prediction unit 111. The lossless decoding unit 102 further supplies the intra prediction mode information or the inter prediction mode information contained in the header to the switch 112.

The inverse quantization unit 103, the inverse orthogonal transform unit 104, the addition unit 105, the deblocking filter 106, the frame memory 109, the intra prediction unit 110, and the inter prediction unit 111 perform the same operations as the inverse quantization unit 18, the inverse orthogonal transform unit 19, the addition unit 20, the deblocking filter 21, the frame memory 22, the intra prediction unit 23, and the inter prediction unit 24 shown in FIG. 4, to decode images.

Specifically, the inverse quantization unit 103 inversely quantizes the quantized coefficients supplied from the lossless decoding unit 102, and supplies the resultant coefficients to the inverse orthogonal transform unit 104.

The inverse orthogonal transform unit 104 performs an inverse orthogonal transform such as an inverse discrete cosine transform or an inverse Karhunen-Loeve transform on the coefficients supplied from the inverse quantization unit 103, and supplies the resultant residual error information to the addition unit 105.

The addition unit 105 functions as an adding operation means, and adds the residual error information as a decoding target image supplied from the inverse orthogonal transform unit 104 to a predicted image supplied from the switch 112. The addition unit 105 supplies the resultant image to the deblocking filter 106, and supplies the resultant image as a reference image to the intra prediction unit 110. If there are no predicted images supplied from the switch 112, the addition unit 105 supplies an image that is the residual error information supplied from the inverse orthogonal transform unit 104, to the deblocking filter 106, and also supplies the image as a reference image to the intra prediction unit 110.

The deblocking filter 106 performs filtering on the image supplied from the addition unit 105, to remove block distortions. The deblocking filter 106 supplies and stores the resultant image into the frame memory 109, and also supplies the resultant image to the screen rearrangement buffer 107. The image stored in the frame memory 109 is supplied as a reference image to the inter prediction unit 111.

The screen rearrangement buffer 107 stores the image supplied from the deblocking filter 106 frame by frame. The screen rearrangement buffer 107 rearranges the frames of the stored image in the original displaying order, instead of the encoding order, and supplies the rearranged image to the D/A converter 108.

The D/A converter 108 performs a D/A conversion on the frame-based image supplied from the screen rearrangement buffer 107, and outputs an output signal.

Using the reference image supplied from the addition unit 105, the intra prediction unit 110 performs an intra prediction in the intra prediction mode indicated by the intra prediction mode information supplied from the lossless decoding unit 102, and generates a predicted image. The intra prediction unit 110 supplies the predicted image to the switch 112.

The inter prediction unit 111 has the same structure as the inter prediction unit 24 shown in FIG. 5. Based on the inter prediction mode information and the motion vector supplied from the lossless decoding unit 102, the inter prediction unit 111 reads a reference image from the frame memory 109. Based on the motion vector and the reference image read from the frame memory 109, the inter prediction unit 111 performs an inter prediction operation. The inter prediction unit 111 supplies the resultant predicted image to the switch 112.

When the intra prediction mode information is supplied from the lossless decoding unit 102, the switch 112 supplies the predicted image supplied from the intra prediction unit 110 to the addition unit 105. When the inter prediction mode information is supplied from the lossless decoding unit 102, on the other hand, the switch 112 supplies the predicted image supplied from the inter prediction unit 111 to the addition unit 105.

### Description of an Operation of the Decoding Device

FIG. 31 is a flowchart for explaining a decoding operation by the decoding device 100 shown in FIG. 30.

This decoding operation is performed every time frame-based compressed image information is input to the decoding device 100, for example.

In step S101 of FIG. 31, the accumulation buffer 101 of the decoding device 100 receives and accumulates frame-based compressed image information from the encoding device 10 shown in FIG. 4. The accumulation buffer 101 supplies the accumulated compressed image information to the lossless decoding unit 102. It should be noted that the procedures of steps S102 through S110 described below are carried out for each macroblock, for example.

In step S102, the lossless decoding unit 102 performs lossless decoding on the compressed image information supplied from the accumulation buffer 101, to obtain quantized coefficients and a header. The lossless decoding unit 102 supplies the quantized coefficients to the inverse quantization unit 103. The lossless decoding unit 102 also supplies intra prediction mode information and the like contained in the header to the intra prediction unit 110, and supplies the motion vector, inter prediction mode information, and the like to the inter prediction unit 111. The lossless decoding unit 102 further supplies the intra prediction mode information or the inter prediction mode information contained in the header to the switch 112.

In step S103, the inverse quantization unit 103 inversely quantizes the quantized coefficients supplied from the lossless decoding unit 102, and supplies the resultant coefficients to the inverse orthogonal transform unit 104.

In step S104, the inverse orthogonal transform unit 104 performs an inverse orthogonal transform on the coefficients supplied from the inverse quantization unit 103, and supplies the resultant residual error information to the addition unit 105.

In step S105, the inter prediction unit 111 determines whether the inter prediction mode information has been supplied from the lossless decoding unit 102. If it is determined in step S105 that the inter prediction mode information has been supplied, the operation moves on to step S106.

In step S106, based on the motion vector and the inter prediction mode information supplied from the lossless decoding unit 102, the inter prediction unit 111 performs the inter prediction operation described with reference to FIG. 29. The inter prediction unit 111 supplies the resultant predicted image to the addition unit 105 via the switch 112, and the operation then moves on to step S108.

If it is determined in step S105 that the inter prediction mode information has not been supplied, or that the intra prediction mode information has been supplied to the intra prediction unit 110, the operation moves on to step S107.

In step S107, using a reference image supplied from the addition unit 105, the intra prediction unit 110 performs an intra prediction in the intra prediction mode indicated by the intra prediction mode information supplied from the lossless decoding unit 102. The intra prediction unit 110 supplies the resultant predicted image to the addition unit 105 via the switch 112, and the operation then moves on to step S108.

In step S108, the addition unit 105 adds the residual error information supplied from the inverse orthogonal transform unit 104 to the predicted image supplied from the switch 112. The addition unit 105 supplies the resultant image to the deblocking filter 106, and also supplies the resultant image as a reference image to the intra prediction unit 110. When the first macroblock of the first frame is processed, there exist no reference pixels, and therefore, the procedures of steps S105 through S108 are not carried out. Instead, an image that is the residual error information is supplied to the deblocking filter 106, and is also supplied as a reference image to the intra prediction unit 110.

In step S109, the deblocking filter 106 performs filtering on the image supplied from the addition unit 105, to remove block distortions.

In step S110, the deblocking filter 106 supplies and stores the filtered image into the frame memory 109, and also supplies the filtered image to the screen rearrangement buffer 107. The image stored in the frame memory 109 is supplied as a reference image to the inter prediction unit 111.

In step S111, the screen rearrangement buffer 107 stores the image supplied from the deblocking filter 106 frame by frame, rearranges the frames of the stored image in the original displaying order, instead of the encoding order, and supplies the rearranged image to the D/A converter 108.

In step S112, the D/A converter 108 performs a D/A conversion on the frame-based image supplied from the screen rearrangement buffer 107, and outputs an output signal.

As described above, when the predicted pixel has a fractional position that is not a ½ pixel position in the horizontal direction and the vertical direction in the reference image in an inter prediction, the decoding device 100 generates the predicted pixel by using reference pixels that are aligned in two directions perpendicular to each other, like the encoding device 10. As a result, the decoding device 100 can reduce processing loads and delays in inter predictions while suppressing decreases in inter prediction precision.

It should be noted that the filter coefficients may be variable. In that case, the FIR filter 42 and the filter coefficient memory 43 are replaced with an adaptive interpolation filter (AIF). Examples of such AIFs are disclosed in the following literatures: Yuri Vatis, Joern Ostermann, “Prediction of P- and B-Frames Using a Two-dimensional Non-separable Adaptive Wiener Interpolation Filter for H.264/AVC”, ITU-T SG16 VCEG 30th Meeting, Hangzhou China, October 2006, Steffen Wittmann, Thomas Wedi, “Separable adaptive interpolation filter”, ITU-T SG16COM16-C219-E, June 2007, Dmytro Rusanovskyy, et al., “Improvements on Enhanced Directional Adaptive Filtering (EDAIF-2)”, COM16-C125-E, January 2009, and others.

In this embodiment, the encoding method is based on H.264/AVC. However, the present invention is not limited to that, and can also be applied to encoding devices and decoding devices that use encoding methods and decoding methods for performing other motion prediction/compensation operations.

The present invention can also be applied to encoding devices and decoding devices that are used for receiving image information (bit streams) compressed by a technique of compressing image information through orthogonal transforms such as discrete cosine transforms and motion compensation, like MPEG, H.26x, and the like, via a network medium such as satellite broadcasting, cable television broadcasting, the Internet, or a portable telephone device. The present invention can also be applied to encoding devices and decoding devices that are used for performing processing on storage media such as optical disks, magnetic disks, and flash memories. Further, the present invention can also be applied to motion prediction/compensation devices installed in those encoding devices and decoding devices.

### Description of a Computer to which the Present Invention is Applied

The above described encoding operation and decoding operation can be performed with hardware, and can also be performed with software. Where encoding operations and decoding operations are performed with software, a program that forms the software is installed into a general-purpose computer or the like.

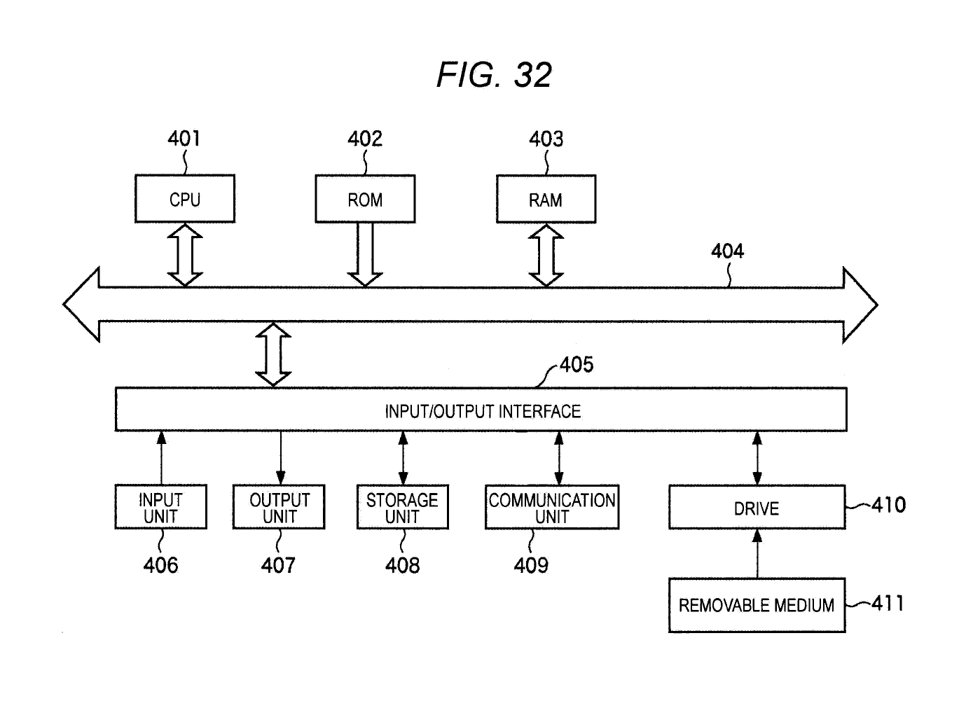

In view of this, FIG. 32 shows an example structure of an embodiment of a computer into which the program for performing the above described series of operations is installed.

The program can be recorded beforehand in a storage unit 408 or a ROM (Read Only Memory) 402 provided as a recording medium in the computer.

Alternatively, the program can be stored (recorded) in a removable medium 411. Such a removable medium 411 can be provided as so-called packaged software. Here, the removable medium 411 may be a flexible disk, a CD-ROM (Compact Disc Read Only Memory), MO (Magneto Optical) disk, a DVD (Digital Versatile Disc), a magnetic disk, or a semiconductor memory, for example.

The program can be installed into the computer from the above described removable medium 411 via a drive 410, but can also be downloaded into the computer via a communication network or a broadcasting network and be installed into the internal storage unit 408. That is, the program can be wirelessly transferred from a download site, for example, to the computer via an artificial satellite for digital satellite broadcasting, or can be transferred by cable to the computer via a network such as a LAN (Local Area Network) or the Internet.

The computer includes a CPU (Central Processing Unit) 401, and an input/output interface 405 is connected to the CPU 401 via a bus 404.

When an instruction is input by a user operating an input unit 406 or the like via the input/output interface 405, the CPU 401 executes the program stored in the ROM 402 accordingly. Alternatively, the CPU 401 loads the program stored in the storage unit 408 into a RAM (Random Access Memory) 403, and executes the program.

By doing so, the CPU 401 performs the operations according to the above described flowcharts, or performs the operations with the structures illustrated in the above described block diagrams. Where necessary, the CPU 401 outputs the operation results from an output unit 407 or transmit the operation results from a communication unit 409, via the input/output interface 405, for example, and further stores the operation results into the storage unit 408.

The input unit 406 is formed with a keyboard, a mouse, a microphone, and the like. The output unit 407 is formed with a LCD (Liquid Crystal Display), a speaker, and the like.

In this specification, the operations performed by the computer in accordance with the program are not necessarily performed in chronological order compliant with the sequences shown in the flowcharts. That is, the operations to be performed by the computer in accordance with the program include operations to be performed in parallel or independently of one another (such as parallel operations or object-based operations).

The program may be executed by one computer (processor), or may be executed in a distributive manner by more than one computer. Further, the program may be transferred to a remote computer, and be executed therein.

### Example Structure of a Television Receiver

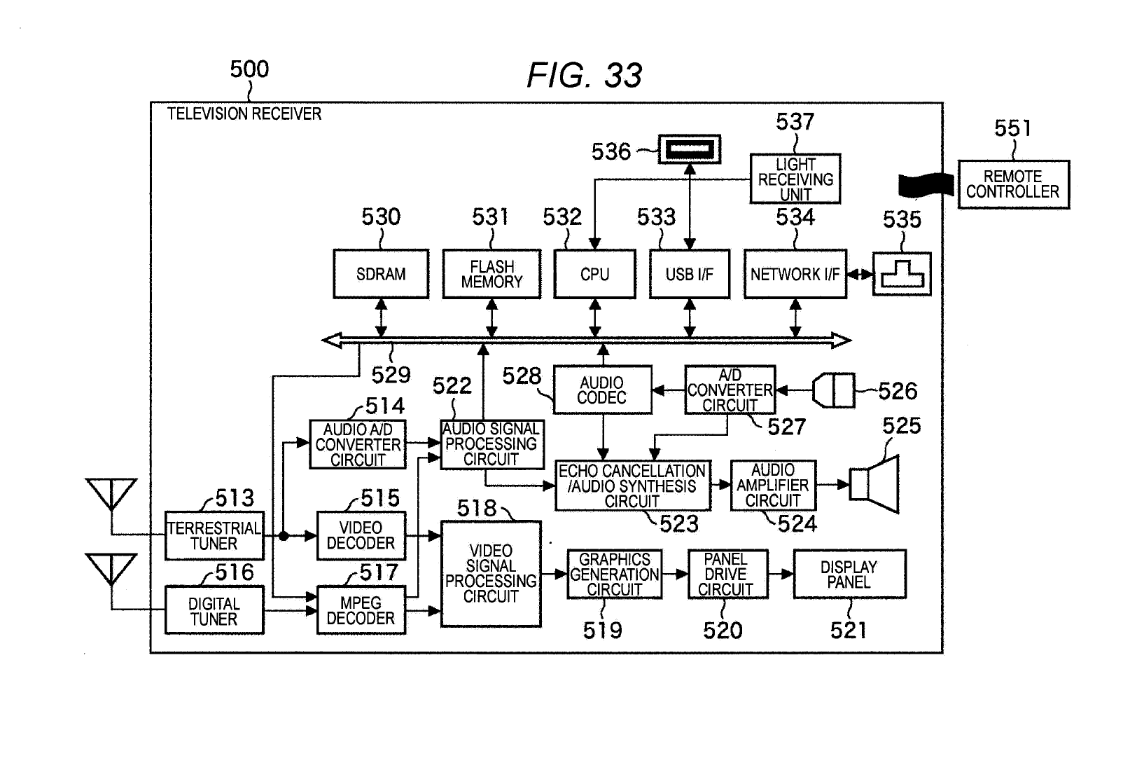

FIG. 33 is a block diagram showing a typical example structure of a television receiver using a decoding device to which the present invention is applied.

The television receiver 500 shown in FIG. 33 includes a terrestrial tuner 513, a video decoder 515, a video signal processing circuit 518, a graphics generation circuit 519, a panel drive circuit 520, and a display panel 521.

The terrestrial tuner 513 receives a broadcast wave signal of analog terrestrial broadcasting via an antenna, and demodulates the signal to obtain a video signal. The terrestrial tuner 513 supplies the video signal to the video decoder 515. The video decoder 515 performs a decoding operation on the video signal supplied from the terrestrial tuner 513, and supplies the resultant digital component signal to the video signal processing circuit 518.

The video signal processing circuit 518 performs predetermined processing such as denoising on the video data supplied from the video decoder 515, and supplies the resultant video data to the graphics generation circuit 519.

The graphics generation circuit 519 generates video data of a show to be displayed on the display panel 521, or generates image data by performing an operation based on an application supplied via a network. The graphics generation circuit 519 supplies the generated video data or image data to the panel drive circuit 520. The graphics generation circuit 519 also generates video data (graphics) for displaying a screen to be used by a user to select an item, and superimposes the video data on the video data of the show. The resultant video data is supplied to the panel drive circuit 520 where appropriate.

Based on the data supplied from the graphics generation circuit 519, the panel drive circuit 520 drives the display panel 521, and causes the display panel 521 to display the video image of the show and each screen described above.

The display panel 521 is formed with an LCD (Liquid Crystal Display) or the like, and displays the video image of a show or the like under the control of the panel drive circuit 520.

The television receiver 500 also includes an audio A/D (Analog/Digital) converter circuit 514, an audio signal processing circuit 522, an echo cancellation/audio synthesis circuit 523, an audio amplifier circuit 524, and a speaker 525.

The terrestrial tuner 513 obtains not only a video signal but also an audio signal by demodulating a received broadcast wave signal. The terrestrial tuner 513 supplies the obtained audio signal to the audio A/D converter circuit 514.

The audio A/D converter circuit 514 performs an A/D converting operation on the audio signal supplied from the terrestrial tuner 513, and supplies the resultant digital audio signal to the audio signal processing circuit 522.

The audio signal processing circuit 522 performs predetermined processing such as denoising on the audio data supplied from the audio A/D converter circuit 514, and supplies the resultant audio data to the echo cancellation/audio synthesis circuit 523.

The echo cancellation/audio synthesis circuit 523 supplies the audio data supplied from the audio signal processing circuit 522 to the audio amplifier circuit 524.

The audio amplifier circuit 524 performs a D/A converting operation and an amplifying operation on the audio data supplied from the echo cancellation/audio synthesis circuit 523. After adjusted to a predetermined sound level, the sound is output from the speaker 525.

The television receiver 500 further includes a digital tuner 516 and an MPEG decoder 517.

The digital tuner 516 receives a broadcast wave signal of digital broadcasting (digital terrestrial broadcasting or digital BS (Broadcasting Satellite)/CS (Communications Satellite) broadcasting) via the antenna, and demodulates the broadcast wave signal, to obtain an MPEG-TS (Moving Picture Experts Group-Transport Stream). The MPEG-TS is supplied to the MPEG decoder 517.

The MPEG decoder 517 descrambles the MPEG-TS supplied from the digital tuner 516, and extracts the stream containing the data of the show to be reproduced (to be viewed). The MPEG decoder 517 decodes the audio packet forming the extracted stream, and supplies the resultant audio data to the audio signal processing circuit 522. The MPEG decoder 517 also decodes the video packet forming the stream, and supplies the resultant video data to the video signal processing circuit 518. The MPEG decoder 517 also supplies EPG (Electronic Program Guide) data extracted from the MPEG-TS to a CPU 532 via a path (not shown).

The television receiver 500 uses the above described decoding device 100 as the MPEG decoder 517, which decodes the video packet as described above. Accordingly, like the decoding device 100, the MPEG decoder 517 can reduce processing loads and delays, while suppressing decreases in inter prediction precision.

The video data supplied from the MPEG decoder 517 is subjected to predetermined processing at the video signal processing circuit 518, as in the case of the video data supplied from the video decoder 515. At the graphics generation circuit 519, generated video data and the like are superimposed on the video data subjected to the predetermined processing, where appropriate. The resultant video data is supplied to the display panel 521 via the panel drive circuit 520, and the image is displayed.

The audio data supplied from the MPEG decoder 517 is subjected to predetermined processing at the audio signal processing circuit 522, as in the case of the audio data supplied from the audio A/D converter circuit 514. The audio data subjected to the predetermined processing is supplied to the audio amplifier circuit 524 via the echo cancellation/audio synthesis circuit 523, and is subjected to a D/A converting operation or an amplifying operation. As a result, a sound that is adjusted to a predetermined sound level is output from the speaker 525.

The television receiver 500 also includes a microphone 526 and an A/D converter circuit 527.

The A/D converter circuit 527 receives a signal of a user's voice captured by the microphone 526 provided for voice conversations in the television receiver 500. The A/D converter circuit 527 performs an A/D converting operation on the received audio signal, and supplies the resultant digital audio data to the echo cancellation/audio synthesis circuit 523.

When audio data of a user (a user A) of the television receiver 500 is supplied from the A/D converter circuit 527, the echo cancellation/audio synthesis circuit 523 performs echo cancellation on the audio data of the user A. After the echo cancellation, the echo cancellation/audio synthesis circuit 523 then combines the audio data with other audio data or the like, and causes the speaker 525 to output the resultant audio data via the audio amplifier circuit 524.

The television receiver 500 further includes an audio codec 528, an internal bus 529, an SDRAM (Synchronous Dynamic Random Access Memory) 530, a flash memory 531, the CPU 532, a USB (Universal Serial Bus) I/F 533, and a network I/F 534.

The A/D converter circuit 527 receives a signal of a user's voice captured by the microphone 526 provided for voice conversations in the television receiver 500. The A/D converter circuit 527 performs an A/D converting operation on the received audio signal, and supplies the resultant digital audio data to the audio codec 528.

The audio codec 528 transforms the audio data supplied from the A/D converter circuit 527 into data in a predetermined format for transmission via a network, and supplies the resultant data to the network I/F 534 via the internal bus 529.

The network I/F 534 is connected to a network via a cable attached to a network terminal 535. The network I/F 534 transmits the audio data supplied from the audio codec 528 to another device connected to the network, for example. The network I/F 534 also receives, via the network terminal 535, audio data transmitted from another device connected to the network, and supplies the audio data to the audio codec 528 via the internal bus 529.

The audio codec 528 transforms the audio data supplied from the network I/F 534 into data in a predetermined format, and supplies the resultant data to the echo cancellation/audio synthesis circuit 523.

The echo cancellation/audio synthesis circuit 523 performs echo cancellation on the audio data supplied from the audio codec 528, and combines the audio data with other audio data or the like. The resultant audio data is output from the speaker 525 via the audio amplifier circuit 524.

The SDRAM 530 stores various kinds of data necessary for the CPU 532 to perform processing.

The flash memory 531 stores the program to be executed by the CPU 532. The program stored in the flash memory 531 is read by the CPU 532 at a predetermined time, such as when the television receiver 500 is activated. The flash memory 531 also stores EPG data obtained through digital broadcasting, data obtained from a predetermined server via a network, and the like.

For example, the flash memory 531 stores a MPEG-TS containing content data obtained from a predetermined server via a network, under the control of the CPU 532. The flash memory 531 supplies the MPEG-TS to the MPEG decoder 517 via the internal bus 529, under the control of the CPU 532, for example.

The MPEG decoder 517 processes the MPEG-TS, as in the case of the MPEG-TS supplied from the digital tuner 516. In this manner, the television receiver 500 receives the content data formed with a video image and a sound via the network, and decodes the content data by using the MPEG decoder 517, to display the video image and output the sound.

The television receiver 500 also includes a light receiving unit 537 that receives an infrared signal transmitted from a remote controller 551.

The light receiving unit 537 receives an infrared ray from the remote controller 551, and performs demodulation. The light receiving unit 537 outputs a control code indicating the contents of a user operation obtained through the demodulation, to the CPU 532.

The CPU 532 executes the program stored in the flash memory 531, and controls the entire operation of the television receiver 500 in accordance with the control code and the like supplied from the light receiving unit 537. The respective components of the television receiver 500 are connected to the CPU 532 via a path (not shown).

The USB I/F 533 exchanges data with an apparatus that is located outside the television receiver 500 and is connected thereto via a USB cable attached to a USB terminal 536. The network I/F 534 is connected to the network via the cable attached to the network terminal 535, and also exchanges data other than audio data with various kinds of devices connected to the network.

By using the decoding device 100 as the MPEG decoder 517, the television receiver 500 can reduce processing loads and delays, while suppressing decreases in inter prediction precision.

### Example Structure of a Portable Telephone Device

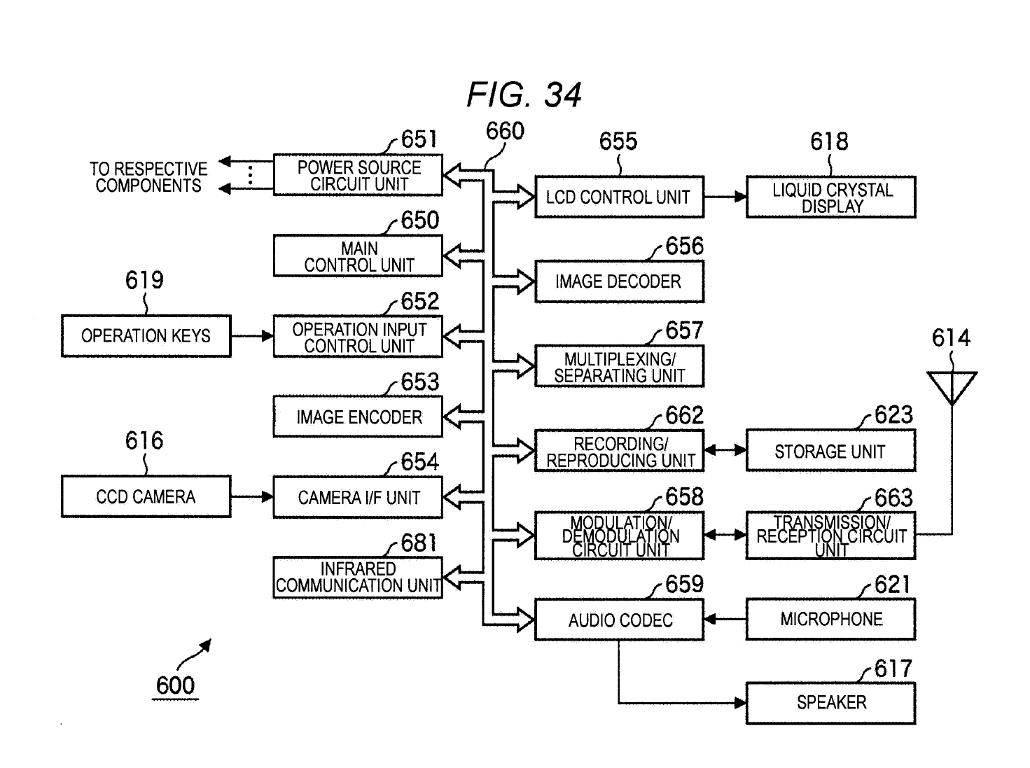

FIG. 34 is a block diagram showing a typical example structure of a portable telephone device using an encoding device and a decoding device to which the present invention is applied.

The portable telephone device 600 shown in FIG. 34 includes a main control unit 650 designed to collectively control respective components, a power source circuit unit 651, an operation input control unit 652, an image encoder 653, a camera I/F unit 654, an LCD control unit 655, an image decoder 656, a multiplexing/separating unit 657, a recording/reproducing unit 662, a modulation/demodulation circuit unit 658, and an audio codec 659. Those components are connected to one another via a bus 660.

The portable telephone device 600 also includes operation keys 619, a CCD (Charge Coupled Device) camera 616, a liquid crystal display 618, a storage unit 623, a transmission/reception circuit unit 663, an antenna 614, a microphone (mike) 621, and a speaker 617.

When a call is ended or the power key is switched on by a user's operation, the power source circuit unit 651 puts the portable telephone device 600 into an operable state by supplying power from a battery pack to the respective components.

Under the control of the main control unit 650 formed with a CPU, a ROM, a RAM, and the like, the portable telephone device 600 performs various kinds of operations, such as transmission and reception of audio signals, transmission and reception of electronic mail and image data, image capturing, and data recording, in various kinds of modes such as a voice communication mode and a data communication mode.

In the portable telephone device 600 in the voice communication mode, for example, an audio signal captured by the microphone (mike) 621 is transformed into digital audio data by the audio codec 659, and the digital audio data is subjected to spread spectrum processing at the modulation/demodulation circuit unit 658. The resultant data is then subjected to a digital-analog converting operation and a frequency converting operation at the transmission/reception circuit unit 663. The portable telephone device 600 transmits the transmission signal obtained through the converting operations to a base station (not shown) via the antenna 614. The transmission signal (audio signal) transmitted to the base station is further supplied to the portable telephone device at the other end of the communication via a public telephone line network.

Also, in the portable telephone device 600 in the voice communication mode, for example, a reception signal received by the antenna 614 is amplified at the transmission/reception circuit unit 663, and is further subjected to a frequency converting operation and an analog-digital converting operation. The resultant signal is subjected to inverse spread spectrum processing at the modulation/demodulation circuit unit 658, and is transformed into an analog audio signal by the audio codec 659. The portable telephone device 600 outputs, from the speaker 617, the analog audio signal obtained through the conversions.

Further, when electronic mail is transmitted in the data communication mode, for example, the operation input control unit 652 of the portable telephone device 600 receives text data of the electronic mail that is input by operating the operation keys 619. The portable telephone device 600 processes the text data at the main control unit 650, and displays the text data as an image on the liquid crystal display 618 via the LCD control unit 655.

In the portable telephone device 600, the main control unit 650 generates electronic mail data, based on text data, a user's instruction, or the like received by the operation input control unit 652. The portable telephone device 600 subjects the electronic mail data to spread spectrum processing at the modulation/demodulation circuit unit 658, and to a digital-analog converting operation and a frequency converting operation at the transmission/reception circuit unit 663. The portable telephone device 600 transmits the transmission signal obtained through the converting operations to a base station (not shown) via the antenna 614. The transmission signal (electronic mail) transmitted to the base station is supplied to a predetermined address via a network, a mail server, and the like.

When electronic mail is received in the data communication mode, for example, the transmission/reception circuit unit 663 of the portable telephone device 600 receives a signal transmitted from a base station via the antenna 614, and the signal is amplified and is further subjected to a frequency converting operation and an analog-digital converting operation. The portable telephone device 600 subjects the received signal to inverse spread spectrum processing at the modulation/demodulation circuit unit 658, to restore the original electronic mail data. The portable telephone device 600 displays the restored electronic mail data on the liquid crystal display 618 via the LCD control unit 655.

The portable telephone device 600 can also record (store) received electronic mail data into the storage unit 623 via the recording/reproducing unit 662.

The storage unit 623 is a rewritable storage medium. The storage unit 623 may be a semiconductor memory such as a RAM or an internal flash memory, a hard disk, or a removable medium such as a magnetic disk, a magnetooptical disk, an optical disk, a USB memory, or a memory card. It is of course possible to use a memory other than the above.

Further, when image data is transmitted in the data communication mode, for example, the portable telephone device 600 generates the image data at the CCD camera 616 capturing an image. The CCD camera 616 includes optical devices such as a lens and a diaphragm, and a CCD as a photoelectric conversion device. The CCD camera 616 captures an image of an object, converts the intensity of the received light into an electrical signal, and generates image data of the image of the object. The image encoder 653 then performs compression encoding on the image data via the camera I/F unit 654 by using a predetermined encoding method such as MPEG2 or MPEG4. Thus, the image data is converted into encoded image data.

The portable telephone device 600 uses the above described encoding device 10 as the image encoder 653 that performs the above operation. Accordingly, like the encoding device 10, the image encoder 653 can reduce processing loads and delays, while suppressing decreases in inter prediction precision.

At the same time as above, in the portable telephone device 600, the sound that is captured by the microphone (mike) 621 during the image capturing by the CCD camera 616 is analog-digital converted at the audio codec 659, and is further encoded.

The multiplexing/separating unit 657 of the portable telephone device 600 multiplexes the encoded image data supplied from the image encoder 653 and the digital audio data supplied from the audio codec 659 by a predetermined method. The portable telephone device 600 subjects the resultant multiplexed data to spread spectrum processing at the modulation/demodulation circuit unit 658, and to a digital-analog converting operation and a frequency converting operation at the transmission/reception circuit unit 663. The portable telephone device 600 transmits the transmission signal obtained through the converting operations to a base station (not shown) via the antenna 614. The transmission signal (image data) transmitted to the base station is supplied to the other end of the communication via a network or the like.

When image data is not transmitted, the portable telephone device 600 can also display image data generated at the CCD camera 616 on the liquid crystal display 618 via the LCD control unit 655, instead of the image encoder 653.

When the data of a moving image file linked to a simplified homepage or the like is received in the data communication mode, for example, the transmission/reception circuit unit 663 of the portable telephone device 600 receives a signal transmitted from a base station via the antenna 614. The signal is amplified, and is further subjected to a frequency converting operation and an analog-digital converting operation. The portable telephone device 600 subjects the received signal to inverse spread spectrum processing at the modulation/demodulation circuit unit 658, to restore the original multiplexed data. The portable telephone device 600 divides the multiplexed data into encoded image data and audio data at the multiplexing/separating unit 657.

By decoding the encoded image data at the image decoder 656 using a decoding method compatible with a predetermined encoding method such as MPEG2 or MPEG4, the portable telephone device 600 generates reproduced moving image data, and displays the reproduced moving image data on the liquid crystal display 618 via the LCD control unit 655. In this manner, the moving image data contained in a moving image file linked to a simplified homepage, for example, is displayed on the liquid crystal display 618.

The portable telephone device 600 uses the above described decoding device 100 as the image decoder 656 that performs the above operation. Accordingly, like the decoding device 100, the image decoder 656 can reduce processing loads and delays, while suppressing decreases in inter prediction precision.

At the same time as above, the portable telephone device 600 transforms the digital audio data into an analog audio signal at the audio codec 659, and outputs the analog audio signal from the speaker 617. In this manner, the audio data contained in a moving image file linked to a simplified homepage, for example, is reproduced.

As in the case of electronic mail, the portable telephone device 600 can also record (store) received data linked to a simplified homepage or the like into the storage unit 623 via the recording/reproducing unit 662.

The main control unit 650 of the portable telephone device 600 can also analyze a two-dimensional code obtained by the CCD camera 616 performing image capturing, and obtain the information recorded in the two-dimensional code.

Further, an infrared communication unit 681 of the portable telephone device 600 can communicate with an external apparatus by using infrared rays.

By using the encoding device 10 as the image encoder 653, the portable telephone device 600 can reduce processing loads and delays, while suppressing decreases in inter prediction precision.

By using the decoding device 100 as the image decoder 656, the portable telephone device 600 can also reduce processing loads and delays, while suppressing decreases in inter prediction precision.

In the above description, the portable telephone device 600 uses the CCD camera 616. However, instead of the CCD camera 616, an image sensor (a CMOS image sensor) using a CMOS (Complementary Metal Oxide Semiconductor) may be used. In that case, the portable telephone device 600 can also capture an image of an object, and generate the image data of the image of the object, as in the case where the CCD camera 616 is used.

Although the portable telephone device 600 has been described above, the encoding device 10 and the decoding device 100 can also be applied to any device in the same manner as in the case of the portable telephone device 600, as long as the device has the same image capturing function and the same communication function as the portable telephone 600. Such a device may be a PDA (Personal Digital Assistant), a smartphone, an UMPC (Ultra Mobile Personal Computer), a netbook, or a notebook personal computer, for example.

### Example Structure of a Hard Disk Recorder

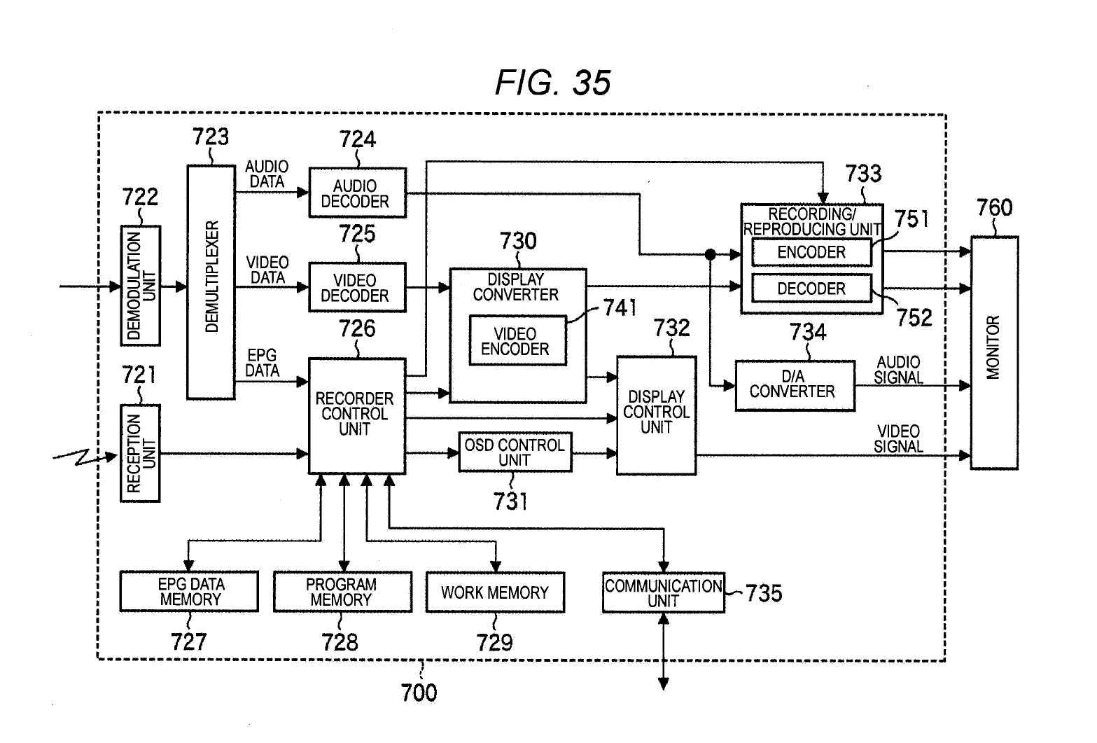

FIG. 35 is a block diagram showing a typical example structure of a hard disk recorder using an encoding device and a decoding device to which the present invention is applied.

The hard disk recorder (a HDD recorder) 700 shown in FIG. 35 is a device that stores, into an internal hard disk, the audio data and the video data of a broadcast show contained in a broadcast wave signal (a television signal) that is transmitted from a satellite or a terrestrial antenna or the like and is received by a tuner, and provides the stored data to a user at a time designated by an instruction from the user.

The hard disk recorder 700 can extract audio data and video data from a broadcast wave signal, for example, decode those data where appropriate, and store the data into an internal hard disk. Also, the hard disk recorder 700 can obtain audio data and video data from another device via a network, for example, decode those data where appropriate, and store the data into an internal hard disk.

Further, the hard disk recorder 700 can decode audio data and video data recorded on an internal hard disk, for example, supply those data to a monitor 760, and display the image on the screen of the monitor 760. The hard disk recorder 700 can also output the sound from the speaker of the monitor 760.

Also, the hard disk recorder 700 can decode audio data and video data extracted from a broadcast wave signal obtained via a tuner, or audio data and video data obtained from another device via a network, for example, supply those data to the monitor 760, and display the image on the screen of the monitor 760. The hard disk recorder 700 can also output the sound from the speaker of the monitor 760.

The hard disk recorder 700 can of course perform operations other than the above.

As shown in FIG. 35, the hard disk recorder 700 includes a reception unit 721, a demodulation unit 722, a demultiplexer 723, an audio decoder 724, a video decoder 725, and a recorder control unit 726. The hard disk recorder 700 further includes an EPG data memory 727, a program memory 728, a work memory 729, a display converter 730, an OSD (On-Screen Display) control unit 731, a display control unit 732, a recording/reproducing unit 733, a D/A converter 734, and a communication unit 735.

The display converter 730 includes a video encoder 741. The recording/reproducing unit 733 includes an encoder 751 and a decoder 752.

The reception unit 721 receives an infrared signal from a remote controller (not shown), converts the infrared signal into an electrical signal, and outputs the electrical signal to the recorder control unit 726. The recorder control unit 726 is formed with a microprocessor, for example, and performs various kinds of operations in accordance with a program stored in the program memory 728. At this point, the recorder control unit 726 uses the work memory 729 where necessary.

The communication unit 735 is connected to a network, and performs a communication operation with another device via the network. For example, under the control of the recorder control unit 726, the communication unit 735 communicates with a tuner (not shown), and outputs a station select control signal mainly to the tuner.

The demodulation unit 722 demodulates a signal supplied from the tuner, and outputs the signal to the demultiplexer 723. The demultiplexer 723 divides the data supplied from the demodulation unit 722 into audio data, video data, and EPG data. The demultiplexer 723 outputs the audio data, the videodata, and the EPG data to the audio decoder 724, the video decoder 725, and the recorder control unit 726, respectively.

The audio decoder 724 decodes the input audio data by an MPEG method, for example, and outputs the decoded audio data to the recording/reproducing unit 733. The video decoder 725 decodes the input video data by the MPEG method, for example, and outputs the decoded video data to the display converter 730. The recorder control unit 726 supplies and stores the input EPG data into the EPG data memory 727.

The display converter 730 encodes video data supplied from the video decoder 725 or the recorder control unit 726 into video data compliant with the NTSC (National Television Standards Committee) standards, for example, using the video encoder 741. The encoded video data is output to the recording/reproducing unit 733. Also, the display converter 730 converts the screen size of video data supplied from the video decoder 725 or the recorder control unit 726 into a size compatible with the size of the monitor 760. The display converter 730 further converts the video data having the converted screen size into video data compliant with the NTSC standards by using the video encoder 741. The NTSC video data is then converted into an analog signal, and is output to the display control unit 732.

Under the control of the recorder control unit 726, the display control unit 732 superimposes an OSD signal output from the OSD (On-Screen Display) control unit 731 on the video signal input from the display converter 730, and outputs the resultant signal to the display of the monitor 760 to display the image.

Audio data that is output from the audio decoder 724 and is converted into an analog signal by the D/A converter 734 is also supplied to the monitor 760. The monitor 760 outputs the audio signal from an internal speaker.

The recording/reproducing unit 733 includes a hard disk as a storage medium for recording video data, audio data, and the like.

The recording/reproducing unit 733 causes the encoder 751 to encode audio data supplied from the audio decoder 724 by an MPEG method, for example. The recording/reproducing unit 733 also causes the encoder 751 to encode video data supplied from the video encoder 741 of the display converter 730 by an MPEG method. The recording/reproducing unit 733 combines the encoded data of the audio data with the encoded data of the video data, using a multiplexer. The recording/reproducing unit 733 amplifies the combined data through channel coding, and writes the resultant data on the hard disk via a recording head.

The recording/reproducing unit 733 reproduces data recorded on the hard disk via a reproduction head, amplifies the data, and divides the data into audio data and video data by using a demultiplexer. The recording/reproducing unit 733 decodes the audio data and the video data by using the decoder 752 by an MPEG method. The recording/reproducing unit 733 performs a D/A conversion on the decoded audio data, and outputs the resultant data to the speaker of the monitor 760. The recording/reproducing unit 733 also performs a D/A conversion on the decoded video data, and outputs the resultant data to the display of the monitor 760.

Based on a user's instruction indicated by an infrared signal that is transmitted from a remote controller and is received via the reception unit 721, the recorder control unit 726 reads the latest EPG data from the EPG data memory 727, and supplies the EPG data to the OSD control unit 731. The OSD control unit 731 generates image data corresponding to the input EPG data, and outputs the image data to the display control unit 732. The display control unit 732 outputs the video data input from the OSD control unit 731 to the display of the monitor 760 to display the image. In this manner, an EPG (Electronic Program Guide) is displayed on the display of the monitor 760.

The hard disk recorder 700 can also obtain various kinds of data, such as video data, audio data, and EPG data, which are supplied from another device via a network such as the Internet.

Under the control of the recorder control unit 726, the communication unit 735 obtains encoded data of video data, audio data, EPG data, and the like from another device via a network, and supplies those data to the recorder control unit 726. For example, the recorder control unit 726 supplies encoded data of obtained video data and audio data to the recording/reproducing unit 733, and stores those data on the hard disk. At this point, the recorder control unit 726 and the recording/reproducing unit 733 may perform an operation such as a re-encoding where necessary.

The recorder control unit 726 also decodes encoded data of obtained video data and audio data, and supplies the resultant video data to the display converter 730. The display converter 730 processes the video data supplied from the recorder control unit 726 in the same manner as processing of video data supplied from the video decoder 725, and supplies the resultant data to the monitor 760 via the display control unit 732 to display the image.

In synchronization with the image display, the recorder control unit 726 may supply the decoded audio data to the monitor 760 via the D/A converter 734, and output the sound from the speaker.

Further, the recorder control unit 726 decodes encoded data of obtained EPG data, and supplies the decoded EPG data to the EPG data memory 727.

The above described hard disk recorder 700 uses the decoding device 100 as the video decoder 725, the decoder 752, and the decoder provided in the recorder control unit 726. Accordingly, like the decoding device 100, the video decoder 725, the decoder 752, and the decoder provided in the recorder control unit 726 can reduce processing loads and delays, while suppressing decreases in inter prediction precision.

The hard disk recorder 700 also uses the encoding device 10 as the encoder 751. Accordingly, like the encoding device 10, the encoder 751 can reduce processing loads and delays, while suppressing decreases in inter prediction precision.

In the above description, the hard disk recorder 700 that records video data and audio data on a hard disk has been described. However, any other recording medium may be used. For example, as in the case of the above described hard disk recorder 700, the encoding device 10 and the decoding device 100 can be applied to a recorder that uses a recording medium such as a flash memory, an optical disk, or a videotape, other than a hard disk.

### Example Structure of a Camera

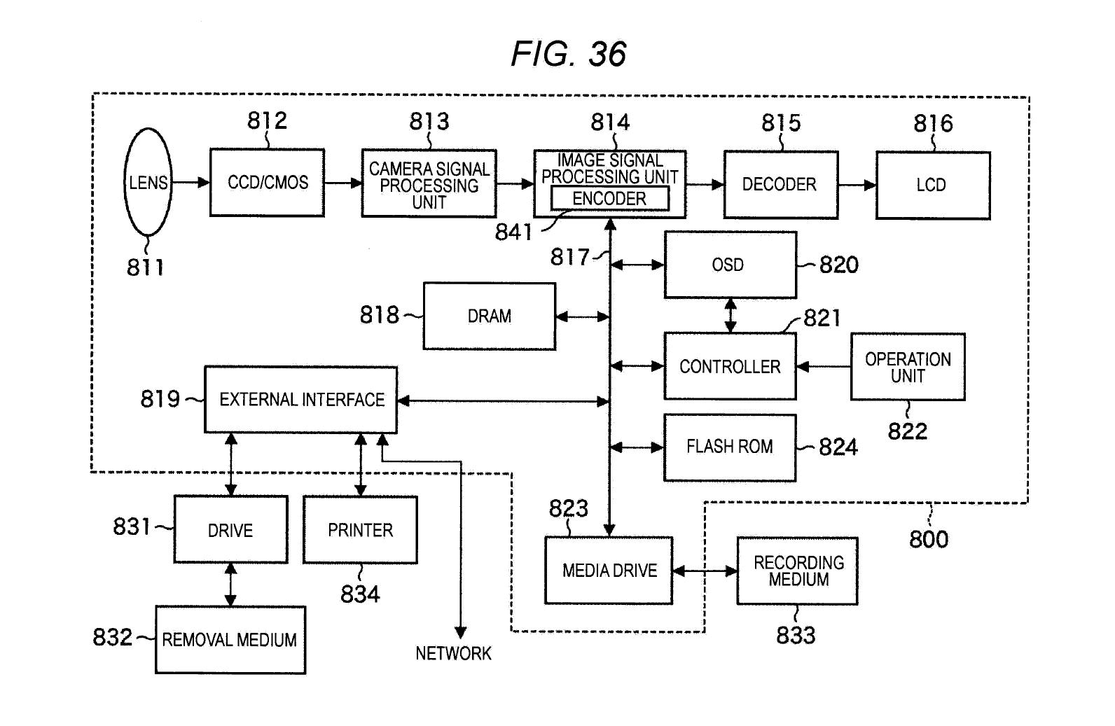

FIG. 36 is a block diagram showing a typical example structure of a camera using an encoding device and a decoding device to which the present invention is applied.

The camera 800 shown in FIG. 36 captures an image of an object, and displays the image of the object on an LCD 816 or records the image of the object as image data on a recording medium 833.

A lens block 811 has light (or a video image of an object) incident on a CCD/CMOS 812. The CCD/CMOS 812 is an image sensor using a CCD or a CMOS. The CCD/CMOS 812 converts the intensity of the received light into an electrical signal, and supplies the electrical signal to a camera signal processing unit 813.

The camera signal processing unit 813 transforms the electrical signal supplied from the CCD/CMOS 812 into a YCrCb chrominance signal, and supplies the signal to an image signal processing unit 814. Under the control of a controller 821, the image signal processing unit 814 performs predetermined image processing on the image signal supplied from the camera signal processing unit 813, and causes the encoder 841 to encode the image signal by an MPEG method. The image signal processing unit 814 supplies the encoded data generated by encoding the image signal to a decoder 815. The image signal processing unit 814 further obtains display data generated at an on-screen display (OSD) 820, and supplies the display data to the decoder 815.

In the above operation, the camera signal processing unit 813 uses a DRAM (Dynamic Random Access Memory) 818 connected thereto via a bus 817, to store the image data and the encoded data or the like generated by encoding the image data into the DRAM 818 where necessary.

The decoder 815 decodes the encoded data supplied from the image signal processing unit 814, and supplies the resultant image data (decoded image data) to the LCD 816. The decoder 815 also supplies the display data supplied from the image signal processing unit 814 to the LCD 816. The LCD 816 combines the image corresponding to the decoded image data supplied from the decoder 815 with the image corresponding to the display data, and displays the combined image.

Under the control of the controller 821, the on-screen display 820 outputs the display data of a menu screen formed with symbols, characters, and figures, and icons, to the image signal processing unit 814 via the bus 817.

Based on a signal indicating contents designated by a user using an operation unit 822, the controller 821 performs various kinds of operations, and controls, via the bus 817, the image signal processing unit 814, the DRAM 818, an external interface 819, the on-screen display 820, a media drive 823, and the like. A flash ROM 824 stores programs, data, and the like necessary for the controller 821 to perform various kinds of operations.

For example, in place of the image signal processing unit 814 and the decoder 815, the controller 821 can encode the image data stored in the DRAM 818, and decode the encoded data stored in the DRAM 818. In doing so, the controller 821 may perform encoding and decoding operations by using the same methods as the encoding and decoding methods used by the image signal processing unit 814 and the decoder 815, or may perform encoding and decoding operations by using methods that are not compatible with the image signal processing unit 814 and the decoder 815.

When a start of image printing is requested through the operation unit 822, for example, the controller 821 reads image data from the DRAM 818, and supplies the image data to a printer 834 connected to the external interface 819 via the bus 817, so that the printing is performed.

Further, when image recording is requested through the operation unit 822, for example, the controller 821 reads encoded data from the DRAM 818, and supplies and stores the encoded data into the recording medium 833 mounted on the media drive 823 via the bus 817.

The recording medium 833 is a readable and writable removable medium, such as a magnetic disk, a magnetooptical disk, an optical disk, or a semiconductor memory. The recording medium 833 may be any kind of removable medium, and may be a tape device, a disk, or a memory card. It is of course possible to use a non-contact IC card or the like.

Alternatively, the media drive 823 and the recording medium 833 may be integrated, and may be formed with an immobile storage medium such as an internal hard disk drive or an SSD (Solid State Drive).

The external interface 819 is formed with a USB input/output terminal and the like, for example, and is connected to the printer 834 when image printing is performed. Also, a drive 831 is connected to the external interface 819 where necessary, and a removable medium 832 such as a magnetic disk, an optical disk, or a magnetooptical disk is mounted on the drive 831 where appropriate. A computer program that is read from such a disk is installed in the flash ROM 824 where necessary.

Further, the external interface 819 includes a network interface connected to a predetermined network such as a LAN or the Internet. In accordance with an instruction from the operation unit 822, for example, the controller 821 can read encoded data from the DRAM 818, and supply the encoded data from the external interface 819 to another device connected thereto via a network. Also, the controller 821 can obtain encoded data and image data supplied from another device via a network, and store the data into the DRAM 818 or supply the data to the image signal processing unit 814 via the external interface 819.

The above described camera 800 uses the decoding device 100 as the decoder 815. Accordingly, like the decoding device 100, the decoder 815 can reduce processing loads and delays, while suppressing decreases in inter prediction precision.

The camera 800 also uses the encoding device 10 as the encoder 841. Accordingly, like the encoding device 10, the encoder 841 can reduce processing loads and delays, while suppressing decreases in inter prediction precision.

The decoding method used by the decoding device 100 may be applied to decoding operations to be performed by the controller 821. Likewise, the encoding method used by the encoding device 10 may be applied to encoding operations to be performed by the controller 821.

Image data to be captured by the camera 800 may be of a moving image, or may be of a still image.

It is of course possible to apply the encoding device 10 and the decoding device 100 to any devices and systems other than the above described devices.

It should be noted that embodiments of the present invention are not limited to the above described embodiments, and various modifications may be made to them without departing from the scope of the invention.

### REFERENCE SIGNS LIST

10 Encoding device, 13 Arithmetic operation unit, 20 Addition unit, 24 Inter prediction unit, 41 Reference pixel read unit 42, FIR filter, 100 Decoding device, 105 Addition unit, 111 Inter prediction unit

1. An image processing device comprising:
a pixel read means that reads predetermined pixels from a reference image in an inter prediction; and
an arithmetic operation means that calculates a pixel in a fractional pixel position in the reference image as a pixel of a predicted image in the inter prediction, by using the predetermined pixels read by the pixel read means,
wherein, when the pixel of the predicted image has a fractional pixel position in a horizontal direction and a vertical direction in the reference image, and the fractional pixel position is not a ½ pixel position, the pixel read means reads the predetermined pixels including pixels aligned in two oblique directions perpendicular to each other in the reference image.

2. The image processing device according to claim 1, wherein the predetermined pixels include pixels equidistant from the position of the pixel of the predicted image in the reference image.

3. The image processing device according to claim 1, wherein, when the pixel of the predicted image has a fractional pixel position in the horizontal direction and the vertical direction in the reference image, and the fractional pixel position is not a ½ pixel position, the pixel read means reads the predetermined pixels including a predetermined number of pixels closest to the position of the pixel of the predicted image in the reference image among the pixels aligned in the two oblique directions perpendicular to each other in the reference image.

4. The image processing device according to claim 1, wherein, when the pixel of the predicted image has a ½ pixel position in the horizontal direction and the vertical direction in the reference image, the pixel read means reads the predetermined pixels including pixels aligned in two directions perpendicular to each other and in another two directions perpendicular to each other in the reference image.

5. The image processing device according to claim 4, wherein, when the pixel of the predicted image has a ½ pixel position in the horizontal direction and the vertical direction in the reference image, the pixel read means reads the predetermined pixels including pixels aligned in the horizontal direction and the vertical direction, and in the two oblique directions perpendicular to each other in the reference image.

6. The image processing device according to claim 1, wherein, when the pixel of the predicted image has a fractional pixel position in one of the horizontal direction and the vertical direction in the reference image, and has an integer pixel position in the other one of the horizontal direction and the vertical direction, the pixel read means reads the predetermined pixels including pixels aligned in two directions perpendicular to each other in the reference image.

7. The image processing device according to claim 6, wherein, when the pixel of the predicted image has a fractional pixel position in one of the horizontal direction and the vertical direction in the reference image, and has an integer pixel position in the other one of the horizontal direction and the vertical direction, the pixel read means reads the predetermined pixels including pixels aligned in the horizontal direction and the vertical direction in the reference image.

8. The image processing device according to claim 1, further comprising
a difference calculation means that calculates a difference between the predicted image and an encoding target image.

9. The image processing device according to claim 1, further comprising
an adding operation means that adds the predicted image to a decoding target image.

10. An image processing method to be performed by an image processing device, comprising:
a pixel read step of reading predetermined pixels from a reference image in an inter prediction; and
an arithmetic operation step of calculating a pixel in a fractional pixel position in the reference image as a pixel of a predicted image in the inter prediction, by using the predetermined pixels read in the pixel read step,
wherein, when the pixel of the predicted image has a fractional pixel position in a horizontal direction and a vertical direction in the reference image, and the fractional pixel position is not a ½ pixel position, the pixel read step includes reading the predetermined pixels including pixels aligned in two oblique directions perpendicular to each other in the reference image.

11. A program for causing a computer to execute:
a pixel read step of reading predetermined pixels from a reference image in an inter prediction; and
an arithmetic operation step of calculating a pixel in a fractional pixel position in the reference image as a pixel of a predicted image in the inter prediction, by using the predetermined pixels read in the pixel read step,
wherein, when the pixel of the predicted image has a fractional pixel position in a horizontal direction and a vertical direction in the reference image, and the fractional pixel position is not a ½ pixel position, the pixel read step includes reading the predetermined pixels including pixels aligned in two oblique directions perpendicular to each other in the reference image.
